(19) United States
(12) Patent Application Publication
(10) Pub. No.: US 2019/0104877 A1
(43) Pub. Date: Apr. 11, 2019

(54) MODULAR TREE WITH LOCKING TRUNK AND LOCKING ELECTRICAL CONNECTORS

(71) Applicant: Willis Electric Co., Ltd., Taipei (TW)

(72) Inventor: Johnny Chen, Taipei (TW)

(21) Appl. No.: 16/154,840

(22) Filed: Oct. 9, 2018

Related U.S. Application Data
(63) Continuation of application No. 15/239,368, filed on Aug. 17, 2016, now Pat. No. 10,098,491.
Application No. 15/239,368 is a continuation of application No. 14/208,058, filed on Mar. 13, 2014, now Pat. No. 9,439,528.
(60) Provisional application No. 61/780,343, filed on Mar. 13, 2013.

(51) Int. Cl. A47G 33/06; A41G 1/00; F21S 4/10; F21V 23/06

(52) U.S. Cl. CPC A47G 33/06; A41G 1/007; A47G 2033/122; F21V 23/06; F21S 4/10

(57) ABSTRACT

An artificial tree that includes a first trunk body having a first elongated projection that extends axially from a first end toward a second end and forms a first keyway; a first electrical connector anchored within the first end of the first trunk body; a second trunk body, including a second elongated projection that extends axially, the second elongated projection forming a second keyway, the second elongated projection configured to be received by the first keyway; and a second electrical connector anchored within a first end of the second trunk body. The second elongated projection is received by the first keyway, and first and second electrical terminals of the first electrical connector make electrical connection with first and second electrical terminals of the second electrical connector, when the first end of the first trunk body is coupled to the first end of the second trunk body.

### CROSS-REFERENCE TO RELATED APPLICATIONS

The present application is a continuation of U.S. patent application Ser. No. 15/239,368, filed Aug. 17, 2016, which is a continuation of U.S. patent application Ser. No. 14/208,058, filed Mar. 13, 2014, now U.S. Pat. No. 9,439,528, issued Sep. 13, 2016, which claims the benefit of U.S. Provisional Application No. 61/780,343 filed Mar. 13, 2013, all of which are hereby incorporated by reference herein in their entireties.

### FIELD OF THE INVENTION

The present invention is generally directed to artificial trees. More specifically, the present invention is directed to artificial trees having separable, modular tree portions mechanically and in some cases, electrically, connectable between trunk portions.

### BACKGROUND OF THE INVENTION

Artificial, decorative trees, such as Christmas trees, generally require some assembly by a user. One common type of artificial tree includes a base and one to four tree sections that are joined together at the trunk. An end of the trunk portion of the first tree section is firstly inserted into the tree base. The user then inserts an end of the trunk portion of the second tree section into the other end of the trunk portion of the first tree section, and so on, until all tree sections are stacked atop one another and the tree is completely assembled.

Avoiding rotation, or twisting of the tree sections can be desirable from an aesthetic standpoint. For example, after a tree is decorated with ornaments and light strings, and perhaps with one side facing a wall, a user would prefer that the tree sections not be rotated about one another so as to preserve the appearance of the decorated, perhaps lit, tree.

In addition to maintaining aesthetic appearances, for pre-lit artificial trees having light strings already attached to the tree sections, and especially for those having wiring extending between trunk sections, it can be particularly useful to avoid rotation of the tree sections about one another. For some designs, if a tree section rotates or twists relative to another, light string wiring can be damaged.

Known solutions for preventing rotation of individual tree sections at the trunk ends range from a simple solution such as ensuring a tight interference fit between trunk ends to using mechanical couplers between tree sections. However, some such designs can be ineffective, or difficult to implement with lighted, artificial trees employing wiring within the individual trunk sections.

### SUMMARY OF THE INVENTION

In an embodiment, the invention comprises an artificial tree defining a central vertical axis, the tree comprising: a first trunk body, including a first end and a second end, the first end including a first elongated projection that extends axially from the first end toward the second end, the first elongated rib forming a first keyway; a first electrical connector anchored within the first end of the first trunk body, the first electrical connector including a first electrical terminal and a second electrical terminal; a second trunk body, including a first end and a second end, the first end including a second elongated projection that extends axially from the first end toward the second end, the second elongated projection forming a second keyway, the second elongated projection configured to be received by the first keyway; a second electrical connector anchored within the first end of the second trunk body, the second electrical connector including a first electrical terminal and a second electrical terminal; wherein the second elongated projection is received by the first keyway, the first electrical terminal of the first electrical connector makes electrical connection with the first electrical terminal of the second electrical connector, and the second electrical terminal of the first electrical connector makes electrical connection with the second electrical terminal of the second electrical connector, when the first end of the first trunk body is coupled to the first end of the second trunk body.

In another embodiment, the invention comprises an artificial tree defining a central vertical axis, the tree comprising: a first trunk body, including a first end and a second end, the first end having a diameter that is less than a diameter of the second end, the first end including a convex projection extending radially outward from the first end; a first electrical connector anchored within the first end of the first trunk body, the first electrical connector including a first electrical terminal and a second electrical terminal, the first electrical terminal aligned along the central vertical axis; a second trunk body, including a first end and a second end, the first end defining an L-shaped slot, the L-shaped slot defining a first portion extending axially from the first end toward the second end and a second a second portion transverse to the first portion, the L-shaped slot configured to receive the convex projection; and a second electrical connector anchored within the first end of the second trunk body, the second electrical connector including a first electrical terminal and a second electrical terminal, the first electrical terminal aligned along the central vertical axis; wherein the L-shaped slot receives the convex projection, the first electrical terminal of the first electrical connector makes electrical connection with the first electrical terminal of the second electrical connector, and the second electrical terminal of the first electrical connector makes electrical connection with the second electrical terminal of the second electrical connector, when the first end of the first trunk body is inserted into the first end of the second trunk body.

In another embodiment, the invention comprises an artificial tree defining a central vertical axis, the tree comprising: a first trunk body, including a first end and a second end; a first electrical connector anchored within the first end of the first trunk body, the first electrical connector including a first end, a second end, a first electrical terminal, a second electrical terminal, the second end having a diameter larger than the first end and defining a keyway; a second trunk body, including a first end and a second end; a second electrical connector anchored within the first end of the second trunk body, the second electrical connector defining a cavity for receiving the first end of the first electrical connector, the second electrical connector including a first electrical terminal, a second electrical terminal, and a key portion, the key portion configured to be received by the keyway of the first electrical connector; wherein the first end of the first electrical connector is received by the cavity of the second electrical connector, the key portion is received by the keyway, the first electrical terminal of the first electrical connector makes electrical connection with the first electrical terminal of the second electrical connector, and the second electrical terminal of the first electrical connector makes electrical connection with the second electrical terminal of the second electrical connector, when the first end of the first trunk body is coupled to the first end of the second trunk body.

### BRIEF DESCRIPTION OF THE FIGURES

The invention can be understood in consideration of the following detailed description of various embodiments of the invention in connection with the accompanying drawings, in which:

FIG. 1 is a front perspective view of a modular, lighted artificial tree, according to an embodiment of the claimed invention;

FIG. 2 is a front view of the tree of FIG. 1, with multiple branches removed;

FIG. 3 is a block diagram of an electrical connection and wiring assembly of the modular, lighted artificial tree of FIG. 1;

FIG. 4A depicts an electrical schematic of a “single-wire” light string, according to an embodiment of the present invention;

FIG. 4B depicts a wiring layout with wires and lamps of the light string of FIG. 4A;

FIG. 4C depicts the light string of FIGS. 4A and 4B attached to a tree branch;

FIG. 5 depicts a wiring layout of a “twisted-pair” light string of the prior art;

FIG. 6 depicts a pair of trunk bodies and a pair of electrical connectors, according to an embodiment of the claimed invention;

FIG. 6A is a cross-sectional view of a trunk body of FIG. 6;

FIG. 7 depicts the pair of trunk bodies and pair of electrical connectors of FIG. 6 in an inverted view;

FIG. 7A is a cross-sectional view of a trunk body of FIG. 7;

FIG. 8 depicts the electrical connectors of FIGS. 6 and 7 assembled into their respective trunk bodies;

FIG. 9 is a cross sectional view of the trunk bodies and electrical connectors of FIG. 8;

FIG. 10 depicts a pair of trunk bodies and a pair of electrical connectors, according to another embodiment of the claimed invention;

FIG. 11 depicts the pair of trunk bodies and pair of electrical connectors of FIG. 10 in an inverted view;

FIG. 12 depicts the electrical connectors of FIGS. 10 and 11 assembled into their respective trunk bodies;

FIG. 13 is a cross sectional view of the trunk bodies and electrical connectors of FIG. 12;

FIG. 14 depicts a pair of trunk bodies and a pair of electrical connectors, according to another embodiment of the claimed invention;

FIG. 15 depicts the pair of trunk bodies and pair of electrical connectors of FIG. 14 in an inverted view;

FIG. 16 depicts the electrical connectors of FIGS. 14 and 15 assembled into their respective trunk bodies;

FIG. 17 is a cross sectional view of the trunk bodies and electrical connectors of FIG. 16;

FIG. 18 depicts a pair of trunk bodies and a pair of electrical connectors, according to another embodiment of the claimed invention;

FIG. 19 depicts the pair of trunk bodies and pair of electrical connectors of FIG. 18 in an inverted view;

FIG. 20 depicts the electrical connectors of FIGS. 18 and 19 assembled into their respective trunk bodies;

FIG. 21 is a cross sectional view of the trunk bodies and electrical connectors of FIG. 20;

FIG. 22A depicts a pair of trunk bodies and a pair of electrical connectors, according to another embodiment of the claimed invention;

FIG. 22B depicts the pair of trunk bodies and pair of electrical connectors of FIG. 22A in an inverted view;

FIG. 23 depicts the electrical connectors of FIGS. 22A and 22B assembled into their respective trunk bodies;

FIG. 24 is a cross sectional view of the trunk bodies and electrical connectors of FIG. 23;

FIG. 25 depicts a pair of trunk bodies and a pair of electrical connectors, according to another embodiment of the claimed invention;

FIG. 26 depicts the pair of trunk bodies and pair of electrical connectors of FIG. 25 in an inverted view;

FIG. 27 depicts the electrical connectors of FIGS. 25 and 26 assembled into their respective trunk bodies;

FIG. 28 is a cross sectional view of the trunk bodies and electrical connectors of FIG. 27;

FIG. 29 depicts a pair of trunk bodies and a pair of electrical connectors, according to another embodiment of the claimed invention;

FIG. 30 depicts the pair of trunk bodies and pair of electrical connectors of FIG. 29 in an inverted view;

FIG. 31 depicts the electrical connectors of FIGS. 29 and 30 assembled into their respective trunk bodies;

FIG. 32 is a cross sectional view of the trunk bodies and electrical connectors of FIG. 31;

FIG. 33 depicts a pair of trunk bodies and a pair of electrical connectors, according to another embodiment of the claimed invention;

FIG. 34 depicts the pair of trunk bodies and pair of electrical connectors of FIG. 33 in an inverted view;

FIG. 35 depicts the electrical connectors of FIGS. 33 and 34 assembled into their respective trunk bodies;

FIG. 36 is a cross sectional view of the trunk bodies and electrical connectors of FIG. 35;

FIG. 37 depicts a pair of trunk bodies and a pair of electrical connectors, according to another embodiment of the claimed invention;

FIG. 38 depicts the pair of trunk bodies and pair of electrical connectors of FIG. 37 in an inverted view;

FIG. 38A is a cross-sectional view of a trunk body of FIG. 38;

FIG. 39 depicts the electrical connectors of FIGS. 37 and 38 assembled into their respective trunk bodies;

FIG. 40 is a cross sectional view of the trunk bodies and electrical connectors of FIG. 39;

FIG. 41 depicts a pair of trunk bodies and a pair of electrical connectors, according to another embodiment of the claimed invention;

FIG. 42 depicts the pair of trunk bodies and pair of electrical connectors of FIG. 41 in an inverted view;

FIG. 43 depicts the electrical connectors of FIGS. 41 and 42 assembled into their respective trunk bodies;

FIG. 44 is a cross sectional view of the trunk bodies and electrical connectors of FIG. 43;

FIG. 45 depicts a pair of trunk bodies and a pair of electrical connectors, according to another embodiment of the claimed invention;

FIG. 46 depicts the pair of trunk bodies and pair of electrical connectors of FIG. 45 in an inverted view;

FIG. 47 depicts the electrical connectors of FIGS. 45 and 46 assembled into their respective trunk bodies;

FIG. 48 is a cross sectional view of the trunk bodies and electrical connectors of FIG. 47;

FIG. 49 depicts a pair of trunk bodies and a pair of electrical connectors, according to another embodiment of the claimed invention;

FIG. 50 depicts the pair of trunk bodies and pair of electrical connectors of FIG. 49 in an inverted view;

FIG. 51 depicts the electrical connectors of FIGS. 49 and 50 assembled into their respective trunk bodies;

FIG. 52 is a cross sectional view of the trunk bodies and electrical connectors of FIG. 51;

FIG. 53 depicts a pair of non-keyed trunk bodies and a pair of keyed electrical connectors, according to another embodiment of the claimed invention;

FIG. 54 depicts the pair of trunk bodies and pair of electrical connectors of FIG. 53 in an inverted view;

FIG. 55 depicts the electrical connectors of FIGS. 53 and 54 assembled into their respective trunk bodies;

FIG. 56 is a cross sectional view of the trunk bodies and electrical connectors of FIG. 55;

FIG. 57 depicts a pair of non-keyed trunk bodies and a pair of keyed electrical connectors, according to another embodiment of the claimed invention;

FIG. 58 depicts the pair of trunk bodies and pair of electrical connectors of FIG. 57 in an inverted view;

FIG. 59 depicts the electrical connectors of FIGS. 57 and 58 assembled into their respective trunk bodies;

FIG. 60 is a cross sectional view of the trunk bodies and electrical connectors of FIG. 59;

FIG. 61 depicts a pair of non-keyed trunk bodies and a pair of keyed electrical connectors, according to another embodiment of the claimed invention;

FIG. 62 depicts the pair of trunk bodies and pair of electrical connectors of FIG. 61 in an inverted view;

FIG. 63 depicts the electrical connectors of FIGS. 61 and 62 assembled into their respective trunk bodies; and

FIG. 64 is a cross sectional view of the trunk bodies and electrical connectors of FIG. 63.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

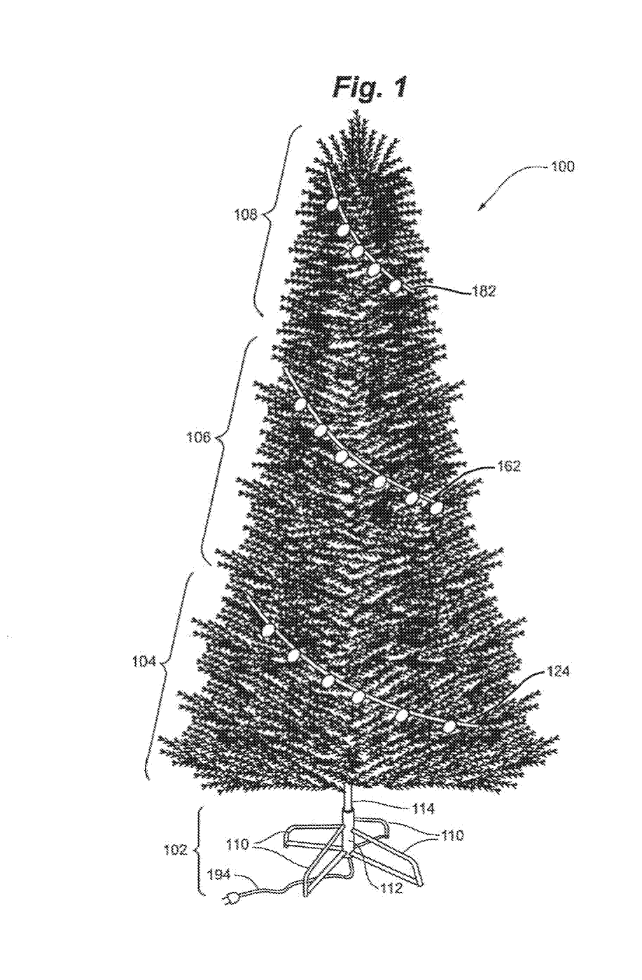

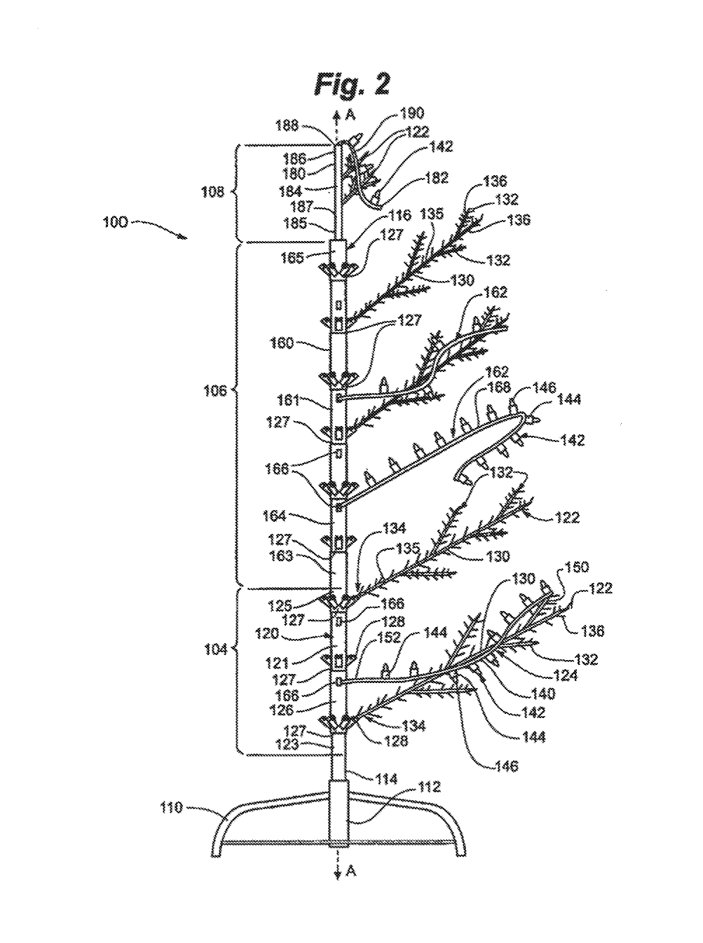

Referring to FIG. 1, an embodiment of modular lighted tree 100 of the present invention is depicted. Modular tree 100 includes base portion 102, first lighted tree portion 104, second lighted tree portion 106, and third lighted tree portion 108. In some embodiments, modular tree 100 may include more tree portions, such as a fourth tree portion, or may include fewer lighted tree portions. The depicted embodiment of modular tree 100 includes light strings, as described further below, but in other embodiments, modular tree 100 is not a lighted tree. When tree 100 is assembled, as depicted, tree portions 104, 106, and 108 are aligned along a common vertical axis A (see FIG. 2) and held in a generally vertical orientation by base portion 102. Base portion 102 as depicted includes multiple legs 110 connected to a central trunk-support portion 112. As depicted, trunk support portion 112 may be generally cylindrical to receive and support first tree portion 104. Base portion 102 may include an optional base-trunk portion 114 extending upwardly from trunk support portion 112 to form a portion of a trunk of tree 100. In other embodiments, base portion 102 may comprise other configurations capable of supporting and aligning tree portions 104, 106, and 108 in a steady, upright manner. Such alternate embodiments include a base portion having more or fewer legs 110, an integrated structure with an opening for receiving first lighted tree portion 104, and other such embodiments.

Referring also to FIG. 2, modular tree 100 is depicted in an assembled configuration, with multiple branches and light strings removed for illustrative purposes.

As depicted, first lighted tree portion 104 includes first trunk portion 120, multiple branches 122, and one or more first light strings 124.

First trunk portion 120 as depicted comprises a generally cylindrical, hollow structure including trunk body 121 having a first end 123, second end 125, outside wall 126, and one or more branch-support rings 127. First trunk portion 120, in an embodiment, also defines multiple openings 166 in wall 126.

Branch-support rings 127 include multiple branch receivers 128 extending outwardly and away from trunk portion 120. In some embodiments, branch receivers 128 define a channel for receiving a trunk end of a branch 122.

Each branch 122 generally includes primary branch extension 130 and may also include multiple secondary branch extensions 132 extending away from branch extension 130. Branch 122 is connected to trunk portion 120 at a branch receiver 128 at trunk-end 134. In some embodiments, as depicted, branches 122 include strands 136 simulating the needles found on natural pine or coniferous trees. Strands 136 are attached to branch frame 135, which in some embodiments comprises a solid-core frame, such as a metal rod, wire, multiple twisted wires or rods, or similar such materials. In other embodiments, frame 135 may be hollow.

Trunk ends of branches 122 may be bent or otherwise formed to define a loop or circular opening such that trunk end 134 of branch 122 may be secured to branch receiver 128 by way of a pin (not depicted) extending through branch receiver 128 and the loop formed at trunk end 134 of branch 122. In this way, a branch 122 may be allowed to pivot about the pin and branch receiver 128, allowing tree portion 104 to collapse to a smaller envelope size for convenient storage. Other embodiments may employ other means to attached branches to trunk sections.

First light string 124 includes light string wiring 140 and a plurality of lighting element assemblies 142. Each lighting assembly element 142 includes housing 144 and lighting element 146. Lighting elements 146 may comprise incandescent bulbs, light-emitting diodes (LEDs), a combination thereof, or any of other known types of light-emitting elements.

As also described below with respect to FIG. 3, lighting elements 146 may be electrically connected in parallel, series, or a combination of series and parallel, to form a parallel-connected, series-connected, parallel-series connected, or series-parallel connected first light string 124.

First light string 124 is affixed to one or more branches 122 of lighted tree portion 104 via multiple clips 150. A proximal end 152 of light string 124 may be connected to outside wall 126 of first trunk portion 120 by a connector or clip as described further below, or may be inserted through an opening 166 in wall 126 into an interior space defined by first trunk portion 120.

In one embodiment, first lighted tree portion 104 includes a plurality of first light strings 124. Such first light strings 124 may be substantially the same, for example, a series-parallel connected light string having 100 lighting element assemblies 142. In other embodiments, first lighted tree portion 104 may include first light strings 124 having a particular configuration and other first light strings 124 having another, different configuration. For example, first light strings 124 located closer to base portion 102 may be longer in length with more light emitting assemblies 142, while first light strings 124 further from base portion 102 may be relatively shorter in length, with fewer light emitting assemblies 142. In other embodiments, first lighted tree portion 104 may include only a single light string 124.

Second lighted tree portion 106, adjacent first lighted tree portion 104, is similar to lighted tree portion 104 and includes second trunk portion 160, multiple branches 122 and one or more second light strings 162.

Second trunk portion 160 as depicted also comprises a generally cylindrical, hollow structure including trunk body 161 having a first end 163, a second end 165, outside wall 164, and one or more branch-support rings 127. First trunk portion 120 also defines multiple openings 166 in wall 164.

In one embodiment, trunk portion 160 may have a trunk diameter that is substantially equal to a trunk diameter of first trunk portion 120, while in other embodiments, may have a trunk diameter that is different from that of the first trunk portion. In one such embodiment, a trunk diameter of second trunk portion 160 is slightly less than a trunk diameter of first trunk portion 120 such that that trunk 116 has a somewhat tapered look.

Similar to first light strings 124, second light strings 162 may comprise any combination of series-connected, series-parallel, parallel-series, or parallel-connected individual or groupings of lighting element assemblies 142.

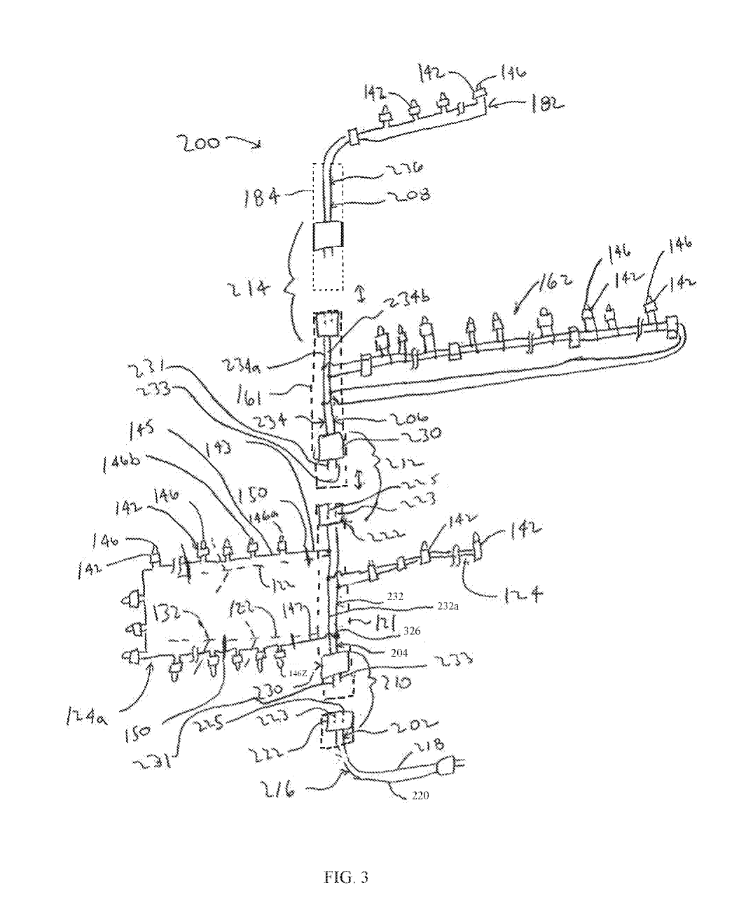

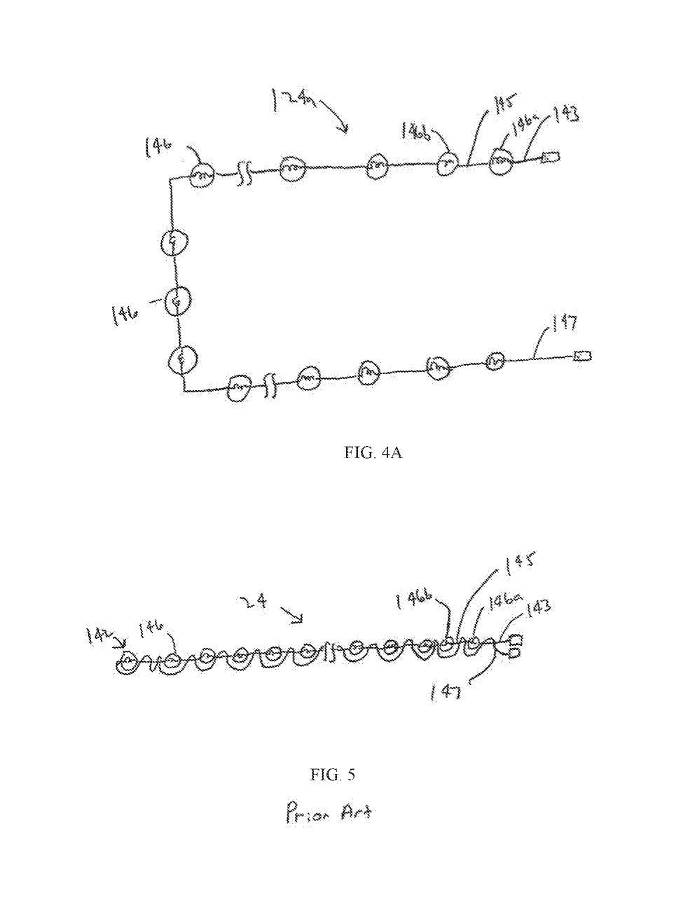

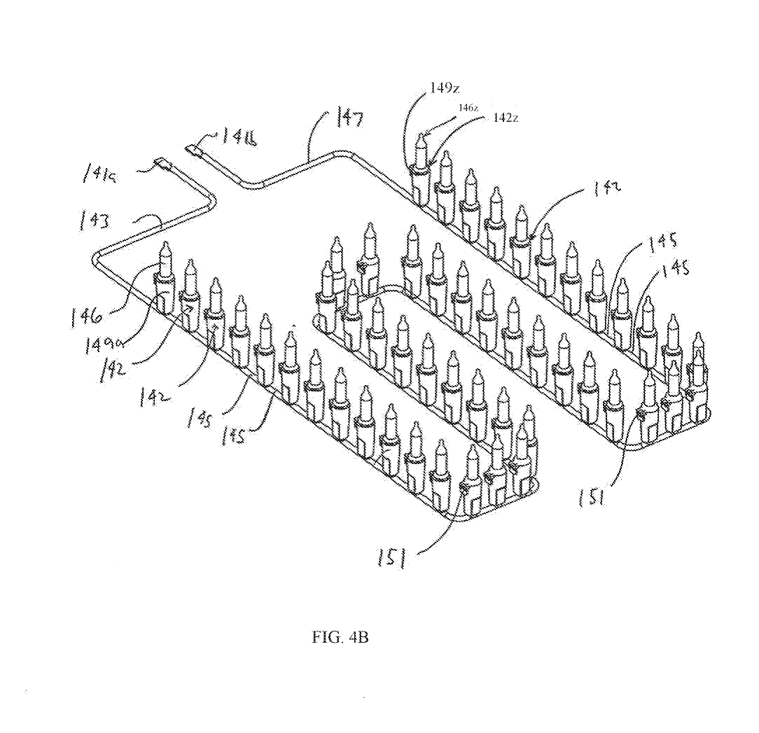

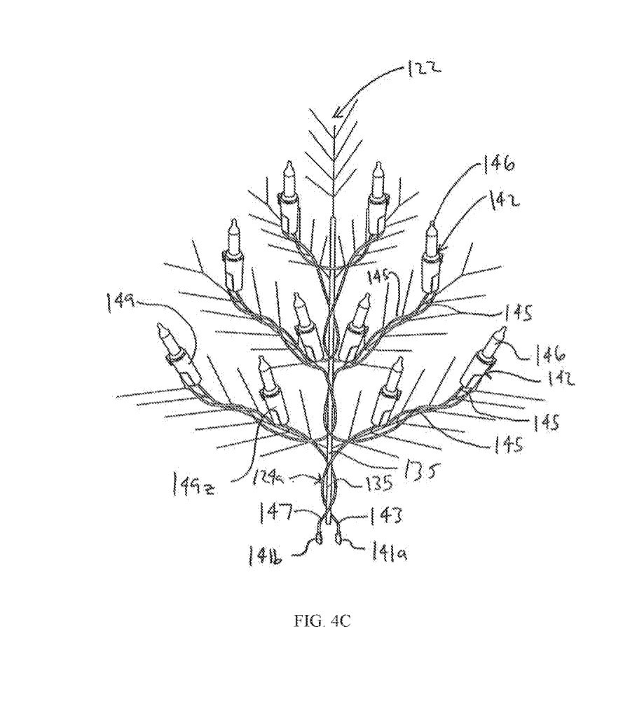

Third lighted tree portion 108, adjacent to second lighted tree portion 106 includes third trunk portion 180, branches 122, and one or more third light strings 182. In some embodiments, such as the depicted embodiment, a diameter of third trunk portion 180 may be somewhat smaller in diameter than a diameter of second lighted tree portion 108. As depicted, third trunk portion 180 comprises a relatively smaller diameter pipe-like body portion 184 including lower end 185, upper end 186, trunk wall 187, and defining top opening 188 (see also FIGS. 3 and 4). Also as depicted, in some embodiments, third trunk portion 180 may also not include branch-support rings 127, as branches 122 of third lighted tree portion 108 may be somewhat shorter in length than branches 122 of second lighted tree sections 106 and may be directly connected to body portion 184 of third trunk portion 180.

Third light string 182 includes wiring 190 and multiple lighting element assemblies 142. Similar to first light strings 124, third light strings 182 may comprise any combination of series-connected or parallel-connected individual or groups of lighting element assemblies 142.

In the embodiment depicted, third light string 182 emerges from top opening 188 such that a portion of third light string 182 is within an interior space defined by third trunk portion 180. Alternatively, third light string 182 may be connected via an electrical connector at opening 188. In other embodiments, third light string is mechanically connected to a trunk portion via a connector at wall 186 of third trunk portion 180, or may be received in part by an opening (not depicted) in wall 186. In yet other embodiments, third light string 182 may be an extension of second light string 162.

Referring to FIG. 3, an embodiment of electrical connection and wiring harness assembly 200 is depicted. In an embodiment, electrical connection and wiring harness assembly 200 includes base portion electrical connection and wiring harness subassembly 202, first tree portion electrical connection and wiring harness subassembly 204, second tree portion electrical connection and wiring harness subassembly 206, and third electrical connection and wiring harness 208. Electrical connection and wiring harness assembly 200 also includes first electrical connector system 210, second electrical connector system 212 and third electrical connector system 214, electrically connecting base 102 to first tree portion 104, first tree portion 104 to second tree portion 106, and second tree portion 106 to third three portion 108.

In an embodiment, base electrical connection and wiring harness subassembly 202 includes power cord 216, first polarity wiring 218 having one or multiple wires, second polarity wiring 220, also having one or multiple wires, electrical connector 222, which in an embodiment is a female connector. Electrical connector 222 includes two or more electrical terminals 223 and 225 electrically connected to wires 220 and 218, respectively.

In an alternate embodiment, power cord 216 connects to wiring harness subassembly 204 and/or electrical connector 230 directly in a simplified electrical system.

First tree portion electrical connection and wiring harness subassembly 204 includes electrical connector 230, wire set 232 having first polarity wire 232a and second polarity wire 232b, and electrical connector 222. It will be understood that herein, “first polarity” and “second polarity” may define opposite polarities, such as a positive and negative polarity (or vice versa) as in the case of direct-current power transmission, or live and neutral “polarities” (or vice versa) as in the case of alternating current (AC) power transmission, or similar. In an embodiment, electrical connector 222 is substantially the same as connector 222 of base portion connector 222. In an embodiment, electrical connector 222 includes two or more electrical terminals 223 and 225 electrically connected to wires 232a and 232b, respectively. In another embodiment, the connectors differ. Electrical connector 230 in the embodiment depicted is a male electrical connector. Electrical connector 230 includes two or more terminals 231 and 233 electrically connected to wires 232a and 232b, respectively.

Second tree portion electrical connection and wiring harness subassembly 206 includes male electrical connector 230, wire set 234 having first polarity wire 234a and second polarity wire 243b, and female electrical connector 222. In an embodiment, electrical connector 222 is substantially the same as connector 222 of base portion connector 222, with terminals 223 and 225 electrically connected to wires 234a and 234b, respectively. In another embodiment, the connectors differ. Male electrical connector 230 includes electrical terminals 231 and 233 electrically connected to wires 234a and 234b, respectively.

Third tree portion electrical connection and wiring harness subassembly 208 includes electrical connector 230 and wire set 236.

It will be understood that for each male/female connecting pair 222/230 the position of each connector could be reversed such that, for example, subassembly 202 includes male connector 230 rather than female connector 222, and the male and female connectors on subassembly 204 are reversed from top to bottom.

Further embodiments of wiring harnesses, wire subassemblies, and electrical connectors are described in pending U.S. patent application Ser. No. 13/112,650, published at US 2012/0076957, and entitled MODULAR LIGHTED TREE, which is incorporated by reference herein in its entirety.

When assembled, base portion electrical connection and wiring harness subassembly 202 plugs into first tree portion electrical connection and wiring harness subassembly 204, which plugs into second tree portion electrical connection and wiring harness subassembly 206, and which plugs into third electrical connection and wiring harness 208 to form tree electrical connection and wiring harness assembly 200.

When assembled, an electrical connection is formed between subassemblies 202, 204, 206, and 208 such that power may be transmitted from an external source via power cord 216 to the various wire sets 232, 234, and 236, and distributed to multiple light sets 124 of tree 100.

Still referring to FIG. 3, and with respect to the various light strings of tree 100, as described briefly above, a number of electrical configurations, using a variety of physical wiring harnesses, are possible. It will be understood that although parallel, series, series-parallel, and parallel-series light strings are depicted on a single tree 100, in embodiments, tree 100 may only include light strings of one electrical configuration type, e.g., all light strings have series connected lighting elements, or all light strings have parallel, or all have parallel-series/series-parallel.

As depicted, first light string 124 is a “parallel” configured light string, such that all lighting elements 146 of lighting assemblies 142 are electrically connected in parallel.

In another embodiment, tree 100 includes light string 124a which as depicted includes series-connected lighting elements 146, though in other embodiments, light string 124a may be a series-parallel configuration.

Light string 124a as depicted is a “single-wire” or single-loop light string. A first wire 143 electrically connects a first lighting element 146a to a first bus wire of wiring 234, and a second wire 145 connects lighting element 146a to lighting element 146b. As such, a “single” wire electrically and mechanically joins the two lighting elements 146a and 146b. A last single wire 147 connects last lighting element 146z to a second bus wire of wiring 234 to complete an electrical series circuit. This configuration allows first wire 143 to be connected to wiring 234 and tree portion 104 at a location different from the location that last wire 147 connects to wiring 234 and tree portion 104, if desired.

One advantage of such an embodiment, is that light string 124a may be distributed amongst multiple branches 130, including branches that may be at different heights along tree portion 104, branches adjacent one another at the same height, branches opposite one another, and so on, without having to bring last wire 147 back to a point close to, or adjacent to, first wire 143. However, in an embodiment, last wire 147 may be brought back to a point close to, or adjacent to, first wire 143. In an alternate embodiment not depicted, light string 124a spans more than one tree portion, with an electrical connector joining a first portion of the light string 124a (associated with first tree portion 104) and a second portion of the light string 124a (associated with second tree portion 106).

Referring to FIGS. 4A and 5, an embodiment of a single-wire construction light string 124a is depicted in FIG. 4, and a traditional twisted pair wire configuration is depicted in FIG. 5.

Referring specifically to FIG. 4A, light string 124a includes a first/lead wire 143 and a last/return wire 147. In an embodiment, none of the single wires, including first wire 143, intermediate wires 145, and last wire 147 are intertwined, or twisted together. In the embodiment depicted, first wire 143 may be located at a first location of tree 100, while last wire 147 may be located at a different location of tree 100. In an alternate embodiment, lead wire 143 may be twisted with return wire 147, but a lead or return wire is not intertwined with other intermediate wires 145.

In an embodiment, a generally non-conductive twine, false wire, or other string-like supporting portion may be intertwined with first, intermediate, and last wires to provide pull strength to light string 124a. In another embodiment, such as the one described with respect to FIG. 4A, no such additional string-like portion is added to single-wire light string 124a.

Conversely, and referring to FIG. 5, a prior art light string 24 includes a last wire 147, often referred to as an electrical “return wire”, that is intertwined with the other single wires of light string 24, including first wire 143 and intermediate wires 145. The twisting of the wires between lighting elements 146 strengthens the mechanical coupling of lighting element assemblies 142. If wires between lighting element assemblies 142 (and lighting elements 146) are pulled, it is less likely that wires will be pulled out of, or disengage from, assemblies 142 when a twisted pair of wires is used in the light string.

On the other hand, a single-wire construction light string 124a does not have the benefit of the added strength of the twisted pair construction of the prior art. As such, it is more vulnerable to loose, damaged or removed wires. Such loosening of wires, or damage to the light string could more easily occur if tree portions, such as 104 and 106, are allowed to rotate about each other. In such a case of rotation about Axis A of one tree portion relative to another, branches from one tree portion may contact and pull on wires of a light string in another tree portion, such as branches 130 of tree portion 104 pulling or snagging a single wire of a light string 124a of tree portion 106.

To avoid such potential damage to single-wire light strings of the claimed invention, an anti-rotation feature embodied by locking trunk and/or locking electrical connectors prevents or limits rotation of one tree portion relative to another tree portion, as will be described further below.

Referring also to FIGS. 4B and 4C, a “single-wire” light string 124a further illustrating the construction details and application to a tree is depicted. Light string 124a of FIG. 4B as depicted is substantially the same as light string 124a as depicted and described with respect to FIG. 4A.

In an embodiment, and as described in part above, light string 124a includes first or lead wire 143 with terminal 141a, a plurality of lighting assemblies 142, a plurality of intermediate wires 145, last or return wire 147 with terminal 141b.

Each lighting assembly 142 includes lighting element 146 and lamp holder 149. Each lamp holder 151 may include lamp lock 151 which locks an adapter or base connected to lighting element 146 to lamp holder 151 so as to prevent lighting element 146 from being accidentally removed from lamp holder 151. Lamp lock device 151 may also serve to orient lighting element 146 to lamp holder 149, such that the electrical polarity of lighting element 146 matches the electrical polarity of lamp holder 149.

Each intermediate wire at a first end is inserted into a lamp holder 149 to make an electrical connection to an electrical lead of a lighting element 146, and at a second end is inserted into a another lamp holder 149 to make an electrical connection with another lighting element 146, as part of the series connection. As depicted, neither first/lead wire 143 nor last/return wire 147 are twisted about intermediate wires 145. In an embodiment, and as depicted, single-wire light string 124a also does not include any other supporting strands woven about intermediate wires 145.

In another embodiment, neither first wire 143 nor last wire 147 are twisted about all of the intermediate wires, but one of wire 143 or 147 may be twisted about some of the intermediate wires, which in an embodiment, means less than half of the intermediate wires 145.

Terminals 141a and 141b may be connected to terminals of wiring harness 204 so as to be electrically connected to a power source.

In an alternate embodiment, lead wires 143 and 147 are integrated into wiring harness subassembly 204. In such an embodiment, terminals of harness 204 may comprise terminals of the type depicted as 141a and 141b. Terminals 141a and 141b may be terminals adapted to be received by a lamp holder 149. In such an embodiment, an electrical connection between an external portion of wiring harness 204 connects to light string 124a at a standard lamp holder 149, thereby avoiding the use of other types of connectors, including connectors at a trunk wall.

In an alternate embodiment, wiring harness first and second power wires 152 and 154 comprise the lead and return wires, and the lamp holders 156 and 158 depicted in FIG. 1 comprise the first and last lamp holders of light string 124, namely 149a and 149z.

In such an embodiment, portions of light string 124a are integrated into wiring harness 204. As such, first wire 143 and last wire 147 of light string 124 are attached to an external portion of light string 124a, extend through opening 136 in trunk body 121, and integrate and attach to wiring harness 204. In an embodiment, first and last wires 143 extend axially inside trunk body 121 to one of electrical connector 222 or 230.

As such, light strings 124a are integrated into a wiring harness substantially inside a trunk of a tree 100, making electrical connection to electrical connectors located at ends of their respective tree portions, and to power cord 216.

First/lead wire 143 and last/return wire 147 extend or enter trunk body 121 (or 161 and so on) through a common opening in the trunk. In other embodiments, wires 143 and 147 may not enter the trunk body at a common opening, but rather, wire 143 may enter at one opening, and wire 147 may enter at another opening. In one such embodiment, lead wire 143 may enter/exit trunk 121 at a first opening 136 at a first tree height, and return wire 147 may enter/exit trunk 121 at a second opening 136 at a second tree height. The first and second tree heights may not be the same.

In the depicted embodiment, first wire 143 and last wire 147 both make electrical connection to a common electrical connector 222 or 230. In alternate embodiments, first wire 143 may connect to an electrical connector 222, while last wire 147 connects to a different electrical connector, connector 230 at the opposite end of the trunk body. In one such embodiment, first wire 143 and last wire 147 do not connect to a common electrical connector, and do not enter/exit the trunk body through a common opening in the trunk body.

In an alternate embodiment, light string 124 comprises a traditional twisted pair light string 124. Unlike the embodiment depicted in FIG. 4A-B, which comprises a “single-wire” light string since only a single wire connects each pair of lamp holders, with no additional wire twisted about the intermediate wire 145, known twisted-pair light strings have a wiring configuration in which either the lead wire or the return wire is spans nearly the entire length of the light string, and is intertwined, or wrapped about, many of the intermediate wires 145. By twisting a lead or return wire about the intermediate wires, it is less likely that an intermediate wire will be accidentally pulled from one of its lamp holders, and less likely that an intermediate wire will be stretched and broken. While the single-wire design as depicted may lack such extra pull strength, other advantages are realized due to the use of less overall wire, including decreased costs and increased aesthetic appearance.

In another embodiment, light string 124 comprises a series-parallel (or parallel-series) light string similar to ones depicted and described in US Patent Publication No. US 2012/0075863, having application Ser. No. 13/112,749, and entitled DECORATIVE LIGHT STRING FOR ARTIFICIAL LIGHTED TREE, which is herein incorporated by reference in its entirety.

Referring specifically to FIG. 4C, light string 124a of the claimed invention is depicted as attached to a branch 122 and branch extension 130. Unlike a twisted pair light string 124 in which a return wire would be twisted with, and follow the intermediate wires 145 throughout the branch and branch extension, return wire 147 is twisted about a portion of branch frame 135 and terminates at last lamp holder 149z. Unlike a traditional twisted pair light string 124, intermediate wires 145 may be twisted about one another as shown (recalling that a traditional twisted pair light string twists intermediate wires with either a lead wire or a return wire). In other embodiments, intermediate wires 145 may not be twisted about one another. The resulting effect of not having a return wire 147 twisted about all intermediate wires 145 is that less overall wire may be used since a return wire of light string 124a will be shorter than a return wire that twists about all intermediate wires. Not only does this save in manufacturing costs, but also improves the aesthetic appearance of tree 100.

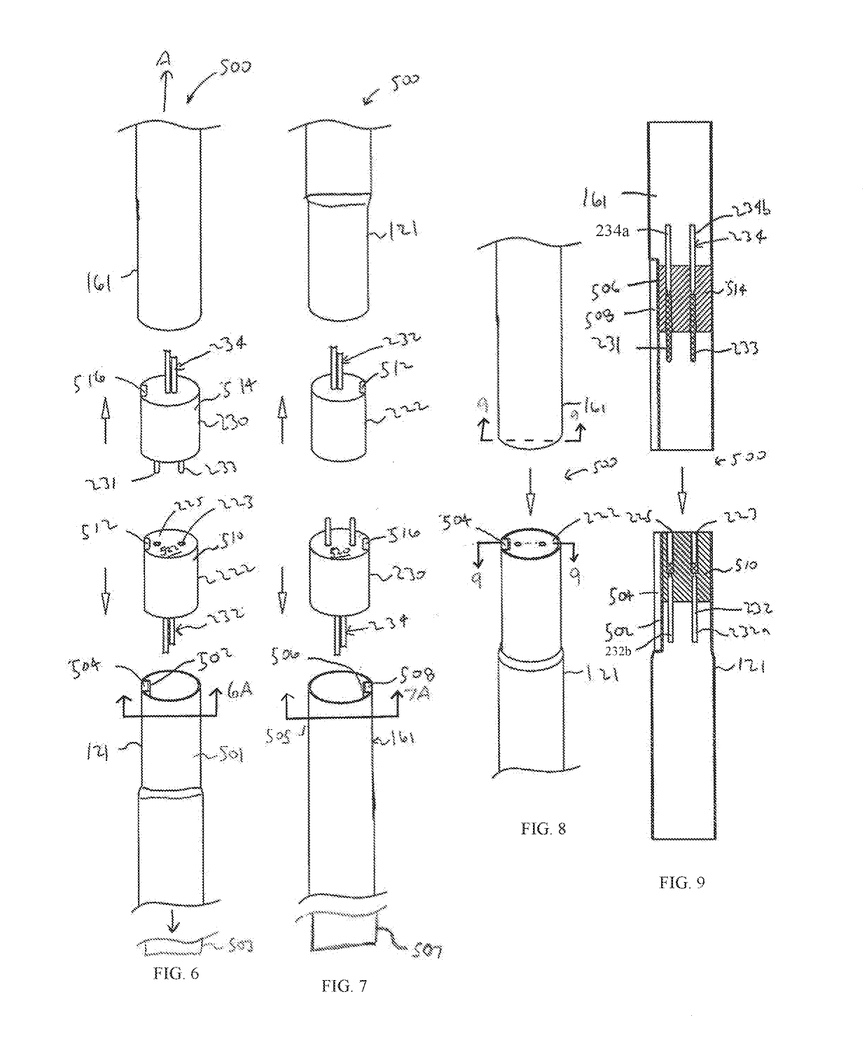

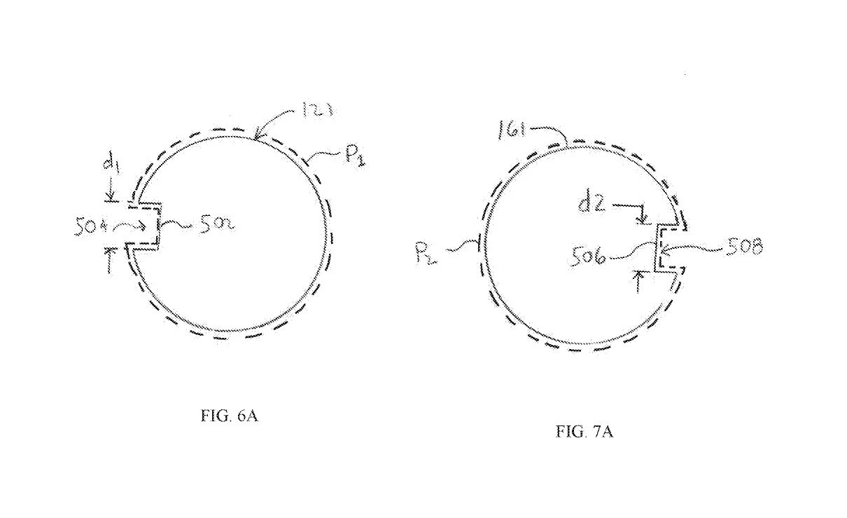

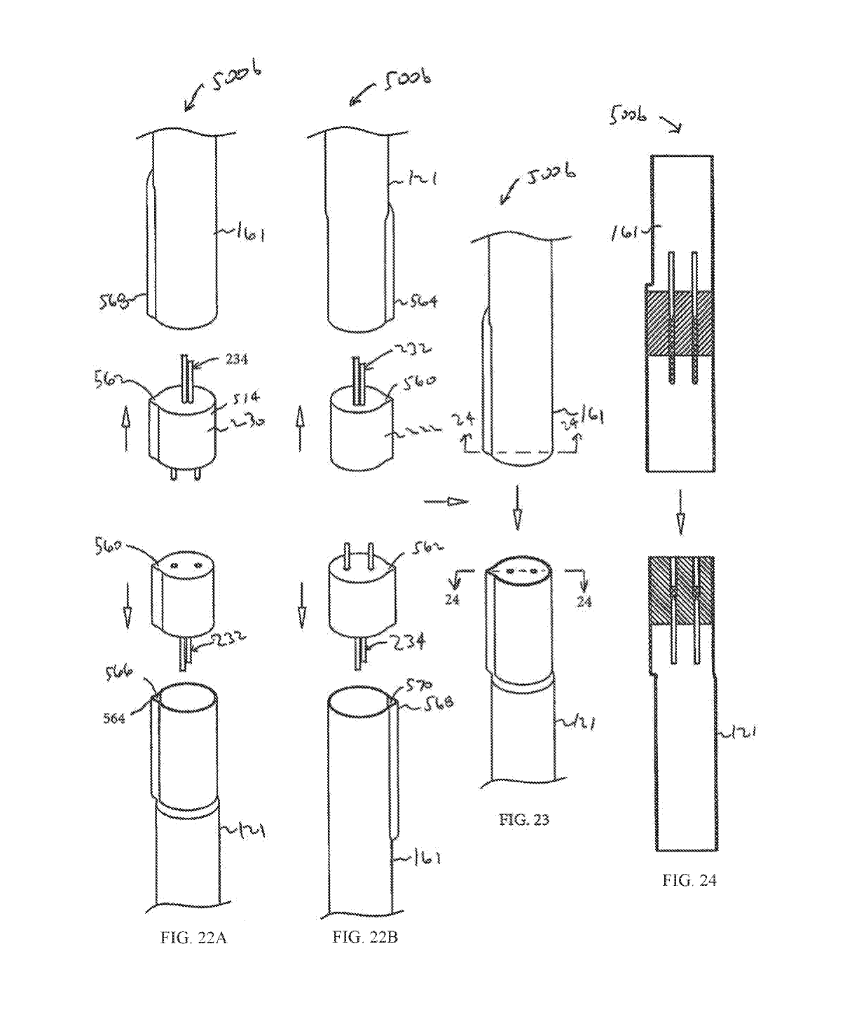

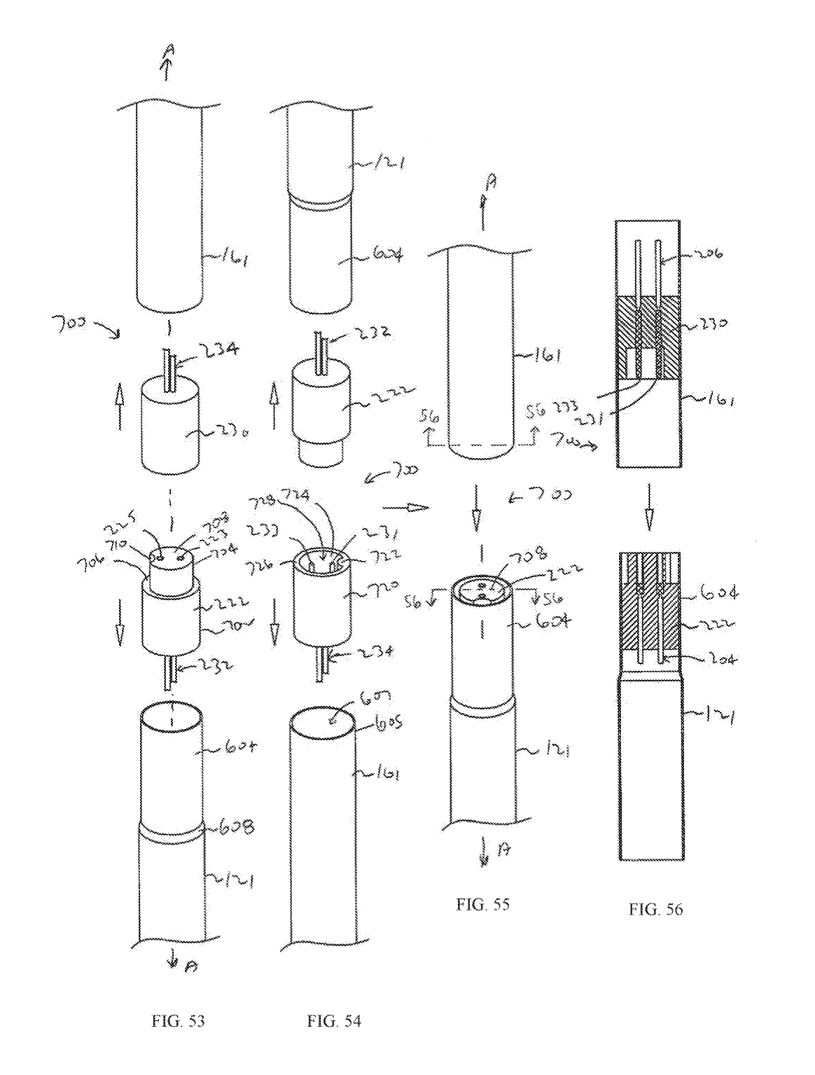

Referring generally to FIGS. 6-64, multiple embodiments of trunk bodies and electrical connectors are depicted. In some embodiments, pairs of trunk bodies couple in a manner that prevents or minimizes rotation of one trunk body to another about an Axis A, resulting in prevention or minimization of rotation of one tree portion relative to another. In some embodiments, the electrical connectors are fit into the trunk body portions such that the electrical connectors cannot rotate relative to one another, or relative to the trunk body that houses it. In some embodiments, both the trunk bodies lock and the electrical connectors lock.

The “locking” of one trunk body to another, or one electrical connector to another, may generally be referred to “one-way keying” or “two-way keying”. In other words, the trunk body ends, and/or the electrical connectors are keyed to one another, and fit in only one orientation or two possible rotational orientations or alignments.

Referring specifically to FIGS. 6-9, an embodiment of a keyed tree trunk system 500 is depicted. In this embodiment, both the trunk bodies 161/121 and the electrical connectors 222/230 are one-way keyed.

Known decorative trees generally comprise trunk sections that are perfectly circular in cross section such that the trunk sections do not need to be rotationally aligned relative to one another when fitting them together. Alternatively, known decorative tree designs may use an intermediate coupler to received and join trunk sections, such as the tree design of US 2010/0072747 to Krize, “Tree Pole Coupler System”. The use of intermediate couplers may result in decreased strength at the joint formed at the connection of the tree sections. In contrast, embodiments of the invention include trunk bodies that may not comprise circular ends, nor rely on intermediate couplers to accomplish keying of tree sections and the forming of strong tree section joints.

In an embodiment, hollow trunk body 121 includes first end 501, second end 503, elongated projection or rib 502 that axially extends towards a center of trunk body 121, and extends vertically and downwardly along an inside wall of trunk body 121. Rib 502 defines channel 504. As will be described further below, rib 502 forms a key that fits into a keyway 512 of connector 222, and channel 504 forms a keyway for a key of trunk body 161. In an embodiment, first end 501 may have an outer diameter that is smaller than second end 503, as depicted.

Referring specifically to FIG. 6A, first end 501 of hollow trunk body 121 is depicted in cross-section, and defines an outer perimeter shape P1. Perimeter shape P1 as depicted is not circular about its entire circumference, but rather, defines an inwardly projecting portion that defines rib 502. In the embodiment depicted, perimeter shape P1 is contiguous (as contrasted to a non-contiguous perimeter shape of the trunk body 161 as depicted in FIGS. 38 and 38A and described below). Keyway 504 defines a diameter d1.

As depicted in FIGS. 6-9, hollow trunk body 161 similarly includes rib or key 506 and defines channel or keyway 508. In an embodiment, key 306 of trunk body 161 is sized to be received by channel or keyway 504. In an embodiment, hollow trunk body 161 includes first end 505 and second end 507. In an embodiment, and as depicted, first end 505 has an outer diameter that is substantially the same as an outer diameter of second end 507.

Referring specifically to FIG. 7A, first end 505 of hollow trunk body 161 is depicted in cross-section, and defines an outer perimeter shape P2. Perimeter shape P2 as depicted is not entirely circular about its entire circumference, but rather, defines an inwardly projecting portion that defines rib 506. In the embodiment depicted, perimeter shape P2 is contiguous (as contrasted to a non-contiguous perimeter shape of the trunk body 161 as depicted in FIGS. 38 and 38A and described below). Key 506 defines a diameter d2. In an embodiment diameter d2 is slightly less than diameter d1 such that key 506 is insertable into keyway 504. In an embodiment perimeter shape P2 is similar, and complementary to perimeter shape P1,

Electrical connector 222 in an embodiment comprises body portion 510 defining keyway or channel 512; electrical connector 230 includes body portion 514 defining channel or keyway 516. In an embodiment, body portions 510 and 514 may comprise a non-conducting material such as a plastic material, including polyethylene, polypropylene, and so on.

During manufacturing assembly, connector 230 confronts trunk body 161 such that keyway 516 is aligned to rib/key 506. Connector 230 is inserted into a hollow end portion of trunk body 161 such that rib 506 slides along channel 516, while keyway 516 receives all or a portion of rib 506. In an embodiment, connector 530 is inserted entirely within trunk body 161, and in the embodiment depicted, top surface 520 of body portion 514 is located a distance from an end opening of trunk body 161. When assembled, in an embodiment, electrical connector 222 cannot rotate within trunk body 161.

As compared to known methods of securing an electrical connector to the inside of a trunk, the arrangement of the invention provides a more secure and robust solution. Known methods typically employ one or several fasteners, such as screws, that are aligned perpendicular to Axis A, and driven through a wall of the trunk and into the connector. Having one, two, or three screws at one to three single points of connection does not rotationally secure a connector to a trunk as securely as the rib and slot arrangement described above, which entails the connector being secured along its entire length.

Connector 230 can only be aligned with, and fit into, trunk body 161 in one rotational orientation or one alignment in order to fit into trunk body 161. As such, electrical connector 230 is keyed to trunk body 161, and keyed in a one-way manner.

During manufacturing assembly, connector 222 confronts trunk body 121 such that keyway 512 is aligned to rib/key 502 (see FIGS. 6 and 7). Connector 222 is inserted into a hollow end portion of trunk body 121 such that rib 502 slides along keyway 512, while keyway 512 receives all or a portion of rib/key 502. In an embodiment, connector 222 is inserted entirely within trunk body 121, and in the embodiment depicted, top surface 522 of body portion 510 is located flush with, or adjacent to, an end opening of trunk body 121. When connected, electrical connector 222 cannot rotate within trunk body 121.

Connector 222 can only be aligned with, and fit into, trunk body 121 in one rotational orientation or one alignment in order to fit into trunk body 121. As such, electrical connector 222 is keyed to trunk body 121, and keyed in a one-way manner.

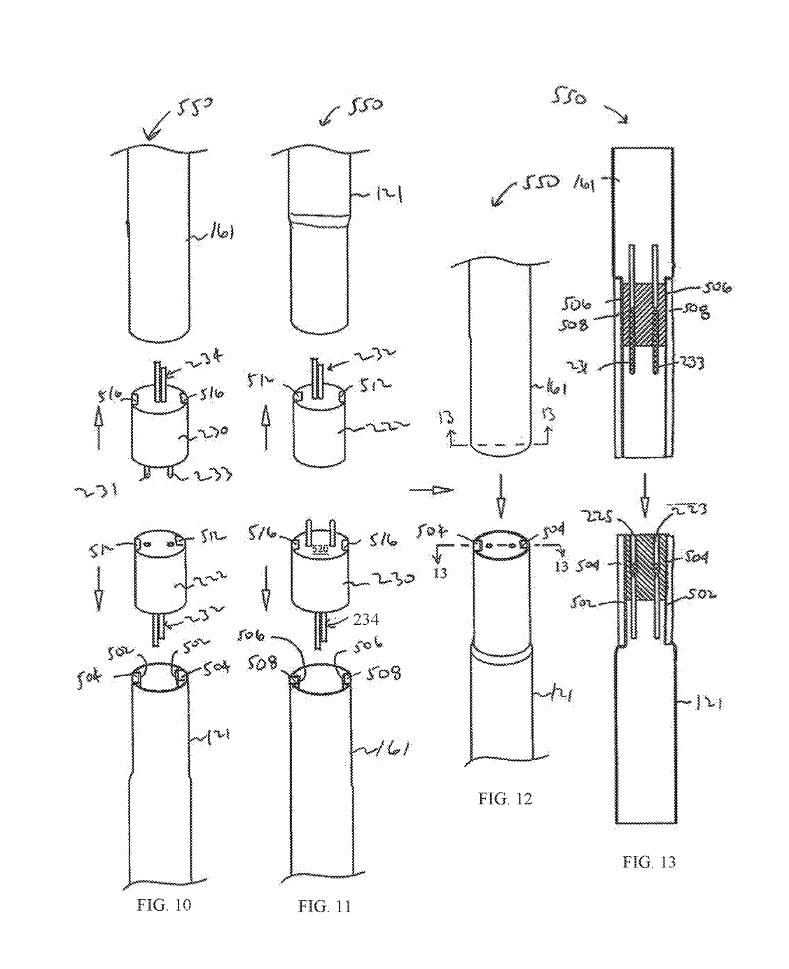

Referring to FIGS. 8 and 9, when a user assembles tree 100 by joining tree portion 102 to tree portion 104, trunk body 161 with connector 230 receives an end of trunk body 121 with connector 222. Rib or key 506 of trunk body 161 fits into channel or keyway 504, allowing the end of trunk body 121 to be slid into trunk body 161. As such, trunk body 121 is keyed to trunk body 161. As described and depicted, the keying is a one-way keying such that the two trunk bodies fit together in only one rotational orientation/alignment. In an alternative embodiment, multiple keys and key ways could be used such that two-way keying, three-way keying, and so on, is possible (see FIGS. 10-13 for two-way keying embodiments).

Although “ribs” and “channels” are described for the key and keyway of system 500, it will be understood that other structural features may comprise keys and keyways of the claimed invention.

Further, it will be understood that while in an embodiment trunk keyway 504 of trunk body 121 is only just large enough to receive trunk key 506 of trunk body 161, such that substantially no rotational movement or twisting between trunk bodies 121 and 161 is possible, in other embodiments, keyway 504 may be somewhat larger than key 506 such that trunk bodies 121 and 161 may more easily be aligned with one another, resulting in some rotational movement upon coupling of the trunk bodies, and hence the tree portions.

At the same time, electrical terminal 233 is received by electrical terminal 223, electrical terminal 231 is received by electrical terminal 225, such that an electrical connection is made between terminals 223 and 233 and between electrical terminals 225 and 231. As such, an electrical connection is made between the two tree portions and their respective wiring harnesses/subassemblies, including between wire sets 232 and 234, and between wires 232a and 234a and between 232b and 234b.

Further, while the above embodiment is described with respect to two particular tree portions 104 and 106, it will be understood that the connection system 500 described above applies equally to other tree portion connections or couplings.

Tree 100 with its trunk-keyed system and connector keyed system provide a number of advantages, some of which have been discussed above. One advantage is that individual tree portions will not rotate relative to one another. In addition to the general aesthetic advantages of non-rotation of a decorated or lighted tree, the one-way keying feature permits the use of single-wire light string as it reduces the risk of loosening or pulling wires from the light string during rotation of tree portions. Another advantage is that the electrical terminals of the respective tree portions will be properly aligned when the respective trunk bodies are aligned, thusly avoiding bent terminals and/or poor electrical connections between tree portions.

In embodiments of tree 100 that include the trunk-keyed system, but with traditional external light strings and without keyed electrical connectors, the trunk-keying prevents relative rotation of the tree portions, which also prevents twisting and damage to light strings that may be attached to branches of a first tree portion and also attached to branches of a second tree portion.

Referring to FIGS. 10-13, a two-way keying system 550 is depicted. System 550 is substantially similar to system 500, except that connectors 222 and 230, and trunk bodies 121 and 161 each include two keys and two keyways.

This two-way keying of both the trunk bodies and the connectors provides the additional advantage that trunk bodies 121 and 161, as well as electrical connectors 222 and 230 can be coupled one of two possible alignments, each alignment or position being 180 degrees opposite.

When assembled, trunk-body keys 502 are received by their respective electrical connector keyways 512; trunk body keys 506 are received by their respective electrical keyways 516; and trunk keys 506 are received by their respective trunk keyways 504, thusly rotationally locking tree portions 104 and 106 via trunk two-way keying and electrical connector two-way keying.

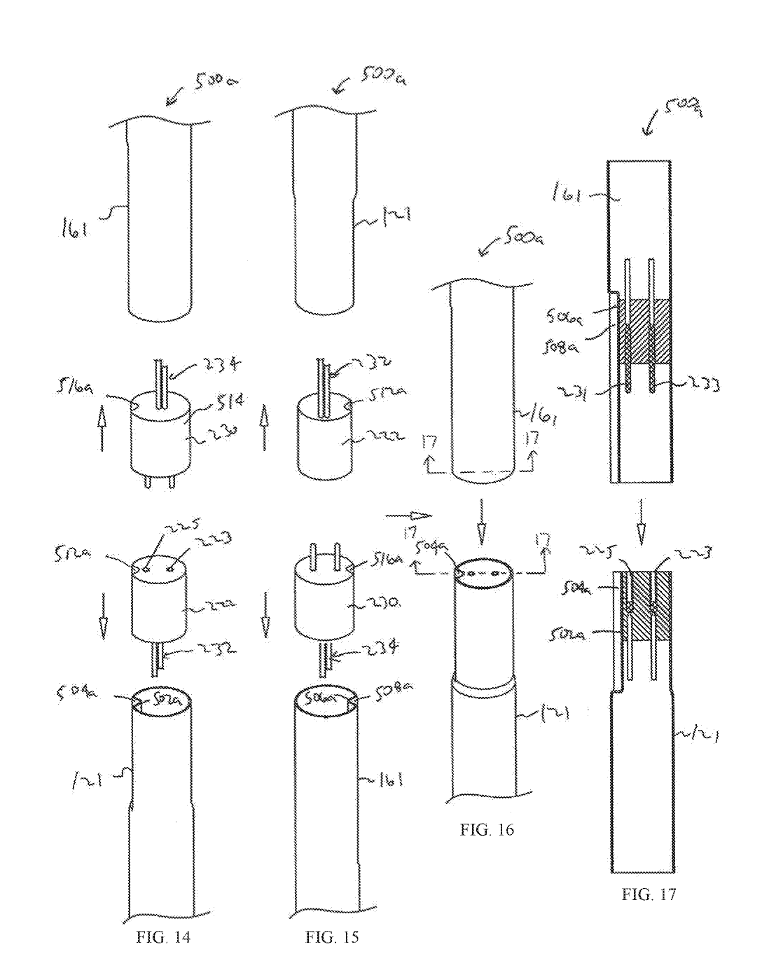

Referring to FIGS. 14-17, another embodiment of keyed tree trunk system 500a is depicted. This embodiment of system 500a is substantially the same as the embodiment of system 500 depicted and described above with respect to FIGS. 6-9, with the primary exception of the key and keyway shapes.

As depicted, trunk keyways 504a and 508a, connector keyways 512a and 516a, trunk key 502a and trunk key 506a, each form a V shape, rather than a rectangular shape as compared to keyways 504 and 508 of FIGS. 6-9. The V shape in some instances may make it easier for a user to align trunk bodies 121 and 161 when joining tree portions 104 and 106. Further, forming a V shape keyway into trunk bodies 121 and 161 in some cases is easier to manufacture as compared to a rectangular shape.

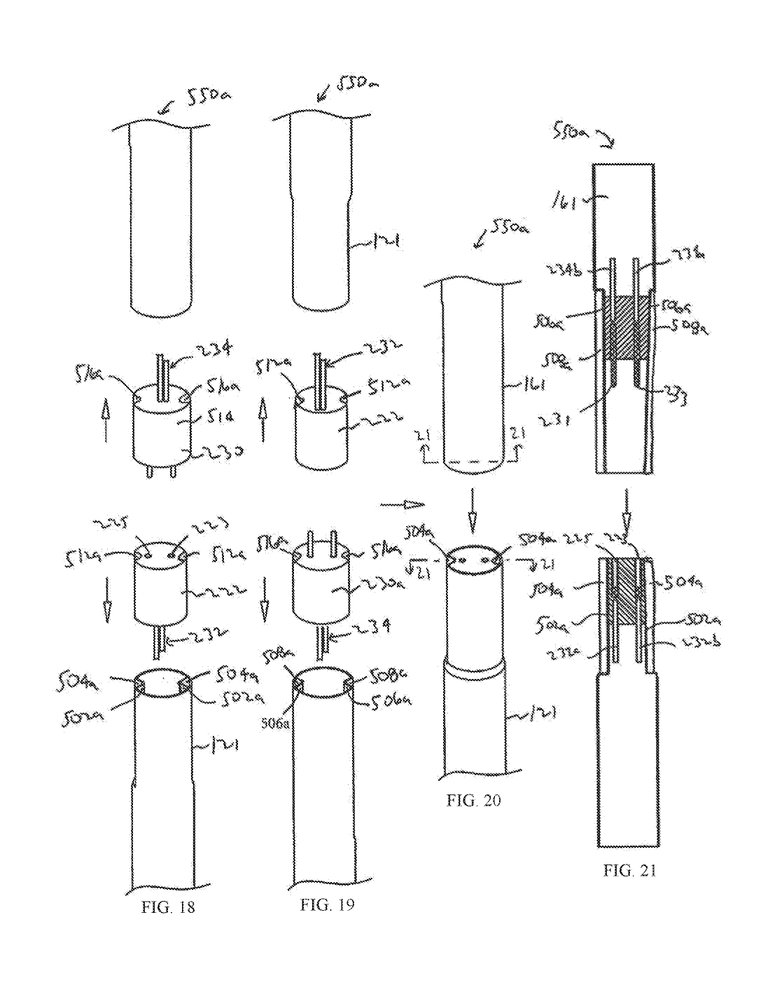

Referring to FIGS. 18-21, a two-way keying system 550a is depicted. System 550a is substantially similar to system 550, except that the keys and keyways are V-shaped, rather than rectangular.

When assembled, trunk body keys 502a are received by their respective electrical connector keyways 512a; trunk body keys 506a are received by their respective electrical keyways 516a; and trunk keys 506a are received by their respective trunk keyways 504a, thusly rotationally locking tree portions 104 and 106 via trunk two-way keying and electrical connector two-way keying.

Referring to FIGS. 22A-24 tree trunk keying system 500b comprises another system featuring one-way trunk keying and one-way electrical connector keying. This embodiment of tree trunk keying system is similar to system 500a. However, in embodiment 500b, electrical connector keyways 512a and 516a are replaced by electrical connector keys 560 and 562. Keys 560 and 562 project radially outwardly and away from centers of trunk bodies 121 and 161, respectively, traversing an axial length of each connector.

Further, the keys and keyways of trunk bodies 121 and 161 are inverted such that they project radially outward and away from centers of trunk bodies 121 and 161. More specifically, trunk body 121 includes key 564 and keyway 566; trunk body 161 includes key 568 and keyway 570.

When assembled, electrical connector keys 560 and 562 are received by their respective trunk keyways 566 and 570; trunk body key 564 is received by trunk keyway 570, thusly rotationally locking tree portions 104 and 106 via trunk two-way keying and electrical connector two-way keying.

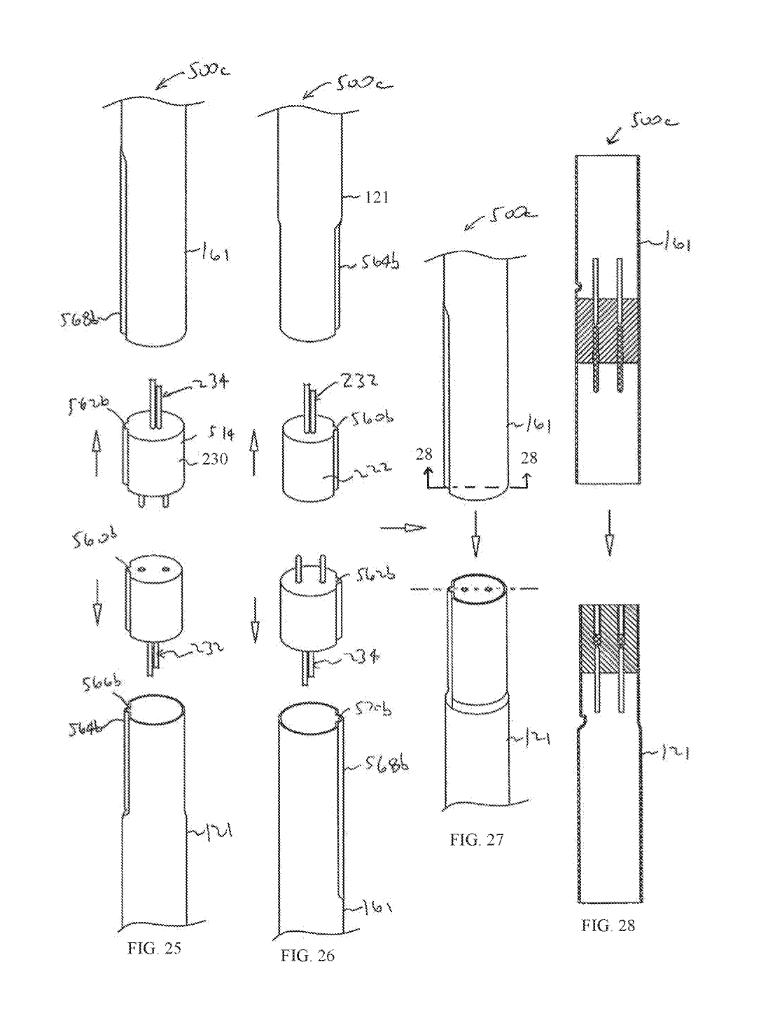

Referring to FIGS. 25-28, tree trunk keying system 500c is depicted. System 500c is substantially the same as system 500b depicted in FIGS. 22-14 with the exception of slightly differently shaped keys and matching keyways that include flat portions.

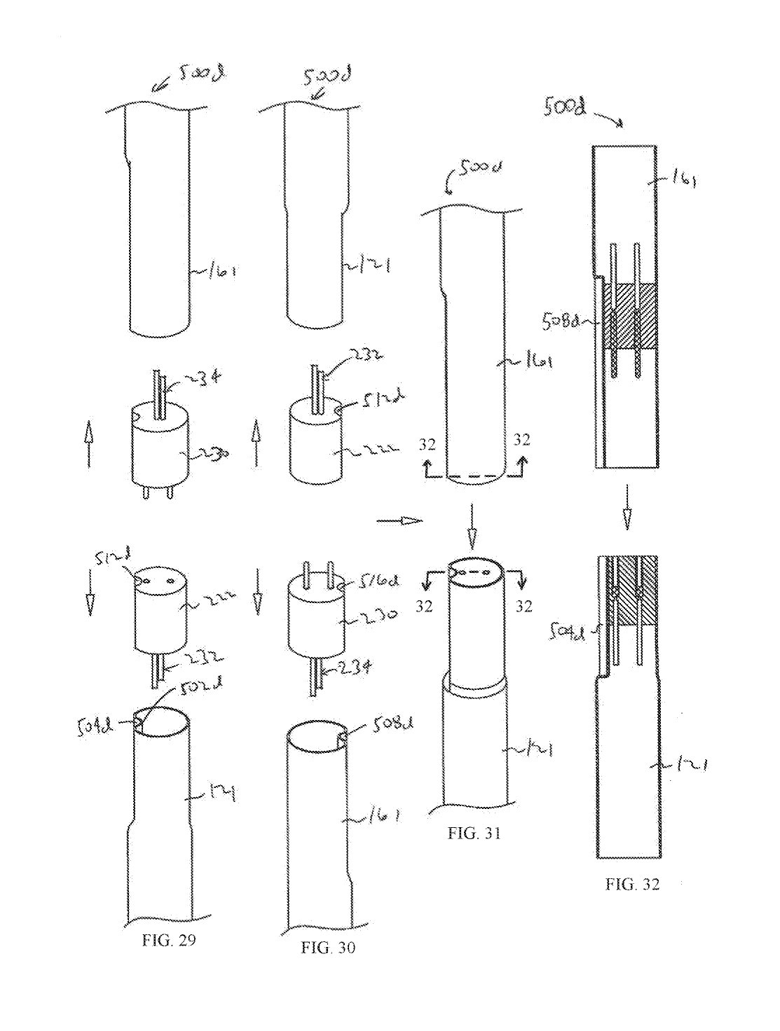

Referring to FIGS. 29-32, tree trunk keying system 500d is depicted. System 500d is substantially the same as system 500a depicted in FIGS. 14-17, with the exception that the keys and keyways are arcuate, or semi-circular in shape, rather than being V-shaped.

Referring to FIGS. 33-36, tree trunk keying system 500e is depicted. System 500e is very similar to system 500, except that the keys and keyways form planar surfaces. Electrical connectors 222 and 230 are both generally circular, but each form a flat, planar surface 570 and 572, respectively. Trunk body 121 forms a flat, planar wall 575; trunk body 576 forms a flat planar wall 576. An outer shape of connector body 514 is complementary to an inside shape of an end of trunk body 121 such that connector 222 fits into trunk body 121. When connector 222 is fit into trunk body 121, surface 570 of connector body 514 is adjacent an inside surface of wall 574 and is unable to rotate within trunk 121.

Connector 230 similarly fits into trunk body 161.

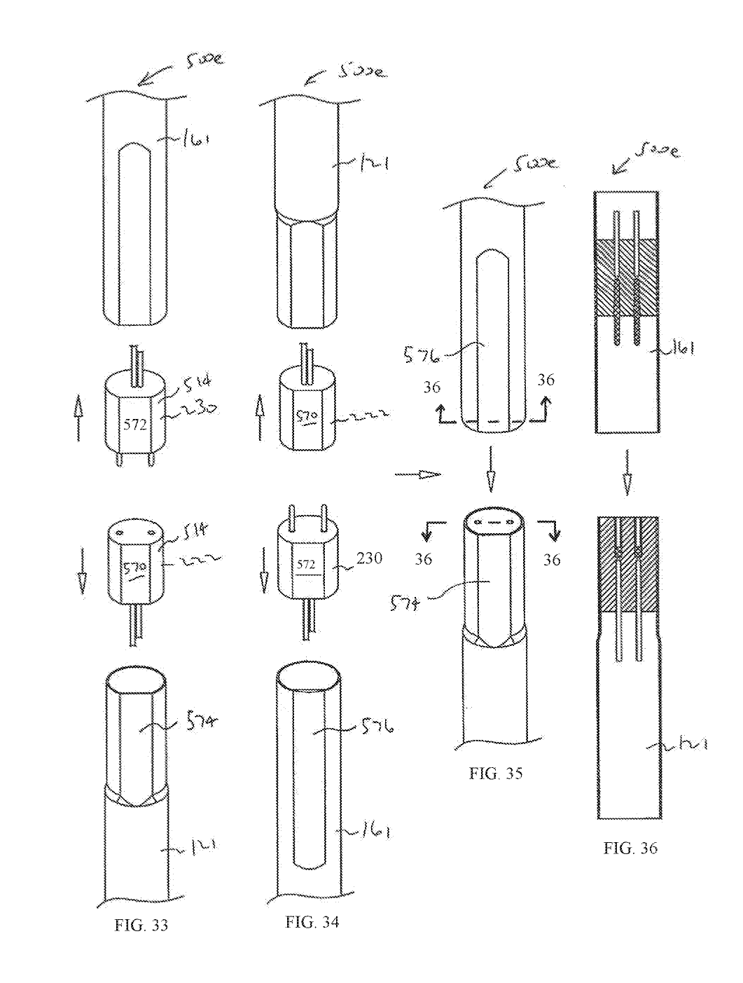

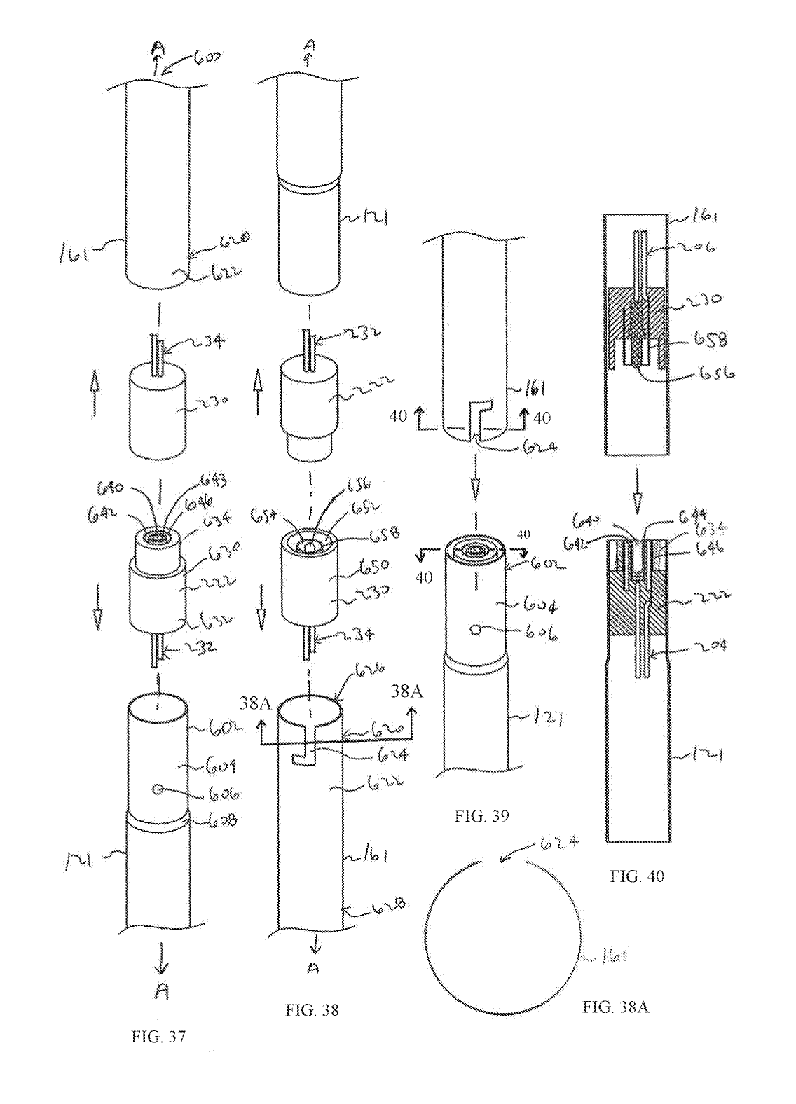

Embodiments of the tree trunk keying systems described above with respect to FIGS. 6-36 include both keyed trunk bodies and keyed electrical connectors. In the embodiments described below in FIGS. 37-44, tree trunk keying systems 600 and 650 include keyed trunk bodies, but not keyed electrical connectors.

Referring specifically to FIGS. 37-40, tree trunk keying system 600 includes trunk body 121, trunk body 161, electrical connector 222 and electrical connector 222.

In an embodiment, trunk body 121 has a generally circular, hollow narrow end 602 comprising trunk wall 604. Trunk wall 604 includes a convex projection 606 that extends radially outwardly from trunk wall 604, and a flanged portion 608.

Trunk body 161 has a generally circular end 620 comprising trunk wall 622, and defining slot 624. Slot 624 extends downwardly from a distal end 626 of end 620 towards a proximal end 628 of end 620. In an embodiment, slot 624 is L-shaped, such that a portion of slot 624 extends circumferentially about end 620. In another embodiment, slot 624 simply extends downwardly and does not form an L shape. Generally, a width of slot 624 is the same size or larger than a width of convex potion 606.

Connector portion 222 includes body portion 630 having a first end 632 and a second end 634. In an embodiment, first end 632 has a larger diameter than a diameter of second end 634. The diameter of first end 634 is such that it will fit into, in some embodiments, snugly fit into, end 604 of trunk body 121.

In an embodiment, second end 634 defines first cylindrical cavity 640 and second cylindrical annular cavity 642. Second end 634 also includes projection 643 separating cavities 640 and 642. In an embodiment, projection 643 is a cylindrical projection.

Connector portion 222 also includes at least two electrical terminals 644 and 646 connected to wiring 206. In an embodiment, terminal 644 is located in first cavity 640 and comprises a ring terminal, cylindrical terminal, or other such contact terminal. In the embodiment depicted, electrical terminal 644 comprises a cylindrical terminal. In an alternate embodiment, electrical terminal 644 comprises a generally flat portion located at an inside bottom of cavity 640. In an embodiment, terminal 646 forms an annular ring at a bottom of cavity 642 and/or comprises a cylindrical shape within cavity 646. Generally, electrical terminals 644 and 646 are coaxial about an Axis A.

Electrical connector 222 during manufacturing assembly is inserted into, and secured end 602 of trunk body 121. Various methods may be used to secure electrical connector 222 to trunk body 121, including using a fastener that penetrates both the trunk body and the connector, thusly fastening the two components together, or using a recess/detent combination.

Electrical connector 230, in an embodiment, comprises body portion defining cavities 652 and 654, and electrical terminals 656 and 658. In an embodiment, electrical terminals 656 and 658 are coaxial about Axis A, and are electrically connected to wiring 204.

Connector 230 during manufacturing assembly is inserted into trunk body 161. In an embodiment, connector 230 is inserted beyond the end opening of trunk body 161, such that it is recessed inside trunk portion 161, such that narrow end 602 may be received by the end portion of trunk body 161 when tree 100 is assembled by a user.

When a user assembles tree 100, trunk body 161 confronts trunk body 121 to align the two bodies. Convex projection 606 is aligned with slot 624. Narrow end 602 is inserted into trunk body 161, such that convex projection 606 travels along the downward extending portion of slot 624. Second end 634 of electrical connector 222 is received by cavity 652 of electrical connector 230; electrical terminal 658 is received by cavity 642; electrical terminal 656 is received by cavity 640. Consequently, electrical terminal 656 makes electrical connection with electrical terminal 644 and electrical terminal 658 makes electrical connection with electrical terminal 646.

After narrow end 604 has been completely received by trunk body 161 and seated fully, a user may then rotate trunk bodies 121 and 161 so as to move convex projection 606 circumferentially along the circumferential (horizontal) portion of slot 624. After this rotation, trunk portion 121 (and tree portion 104) is “locked” relative to trunk portion 161 (and tree portion 106) such that any opposing forces applied to trunk portions 121 and 161 along Axis A will not separate the trunk bodies.

As such, trunk bodies 121 and 161 are keyed to one another via key/convex projection 606 and keyway/slot 624. While trunk bodies 121 and 161 are keyed and limited in their rotational orientations, electrical connectors 230 and 222 are allowed to rotate relative to one another to any degree due to their coaxial nature.

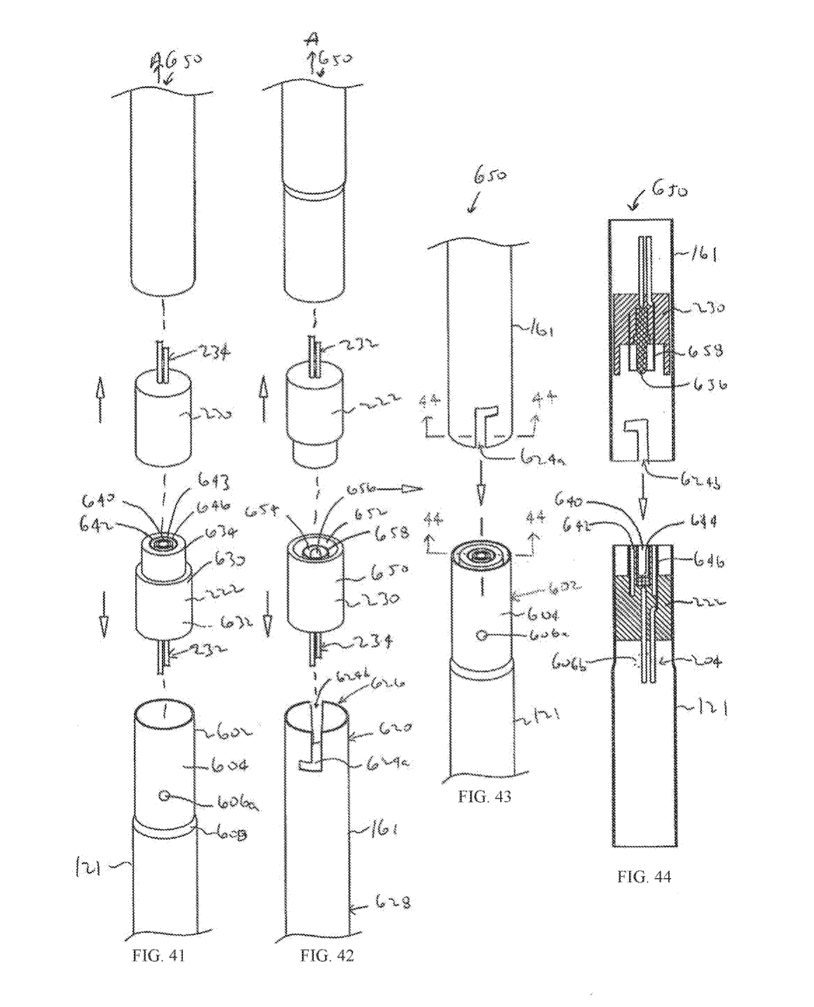

Referring to FIGS. 41-44, a two-way keyed tree trunk keying system 650 is depicted. System 650 is substantially the same as system 600, with the exception that trunk body 121 includes two convex projections, 606a and 606b, and two slots, 624a and 624b. In such a configuration, trunk body 121 may be aligned to trunk body 161 in one of two positions.

When trunk body 121 is inserted into trunk body 161 and rotated, convex projections 606 in slots 624 prevent the trunk bodies from being separated alone Axis A.

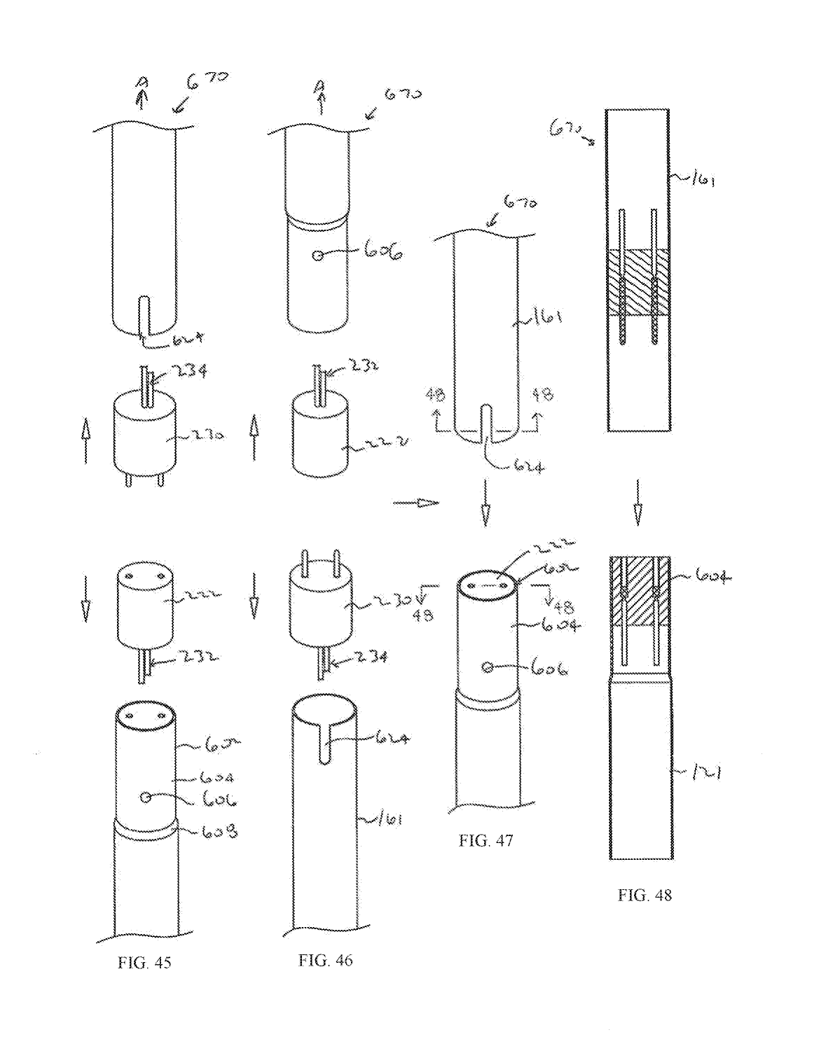

Referring to FIGS. 45-48, another embodiment of a tree trunk keying system, system 670 is depicted. System 670 is substantially similar to system 650 and system 500. In this embodiment, slot 624 is not L shaped, but rather, comprises a single linear, straight line slot, such that trunk body 121 aligns with trunk body 161 in only one rotational alignment. Further, system 670 comprises electrical connectors that are the same as those of system 500 as described above.

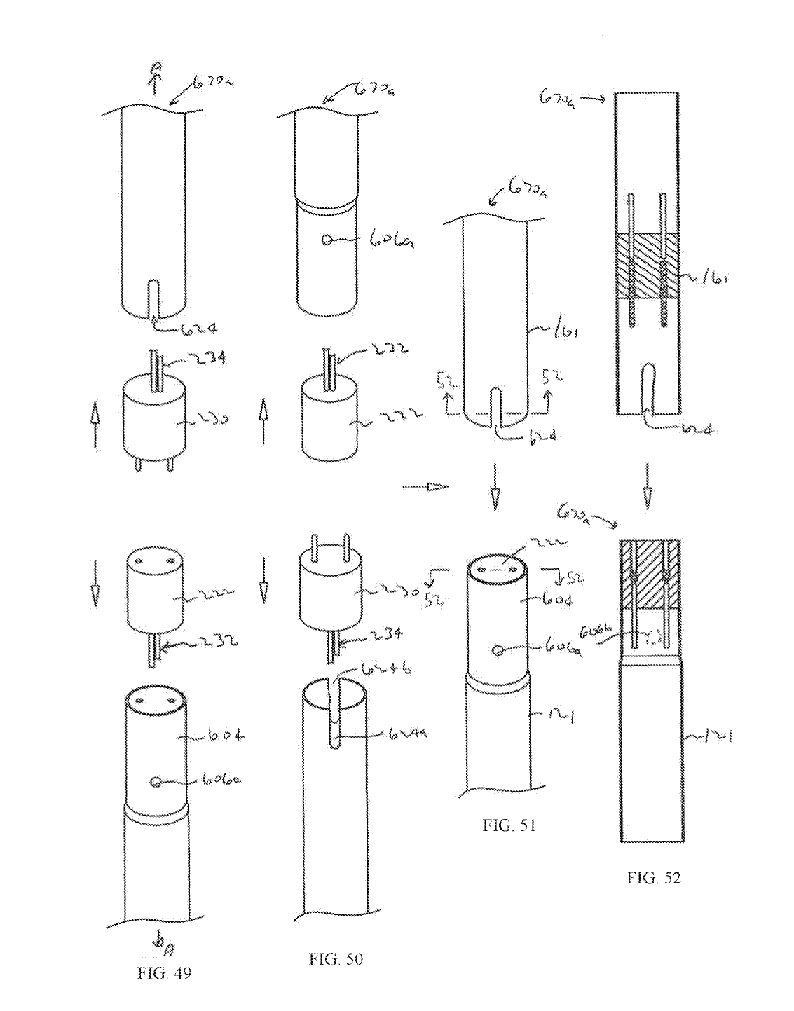

Referring to FIGS. 49-52, system 670a is substantially the same as system 670, with the exception of having two convex projections, 606a and 606b, and two slots, 624a and 624b.

Referring to FIGS. 53-64, various embodiments of tree trunk keyed systems are depicted. These further embodiments include keyed electrical connectors, but do not included keyed trunk bodies. Alignment and rotation locking of trunk and tree portions is accomplished solely via the structural keying features of the electrical connector assemblies, rather than the trunk bodies. Some users may find such systems to be easier to align and assemble since the trunk bodies do not initially have to be aligned, as described further below.

Referring specifically to FIGS. 53-56, tree trunk keying system 700 is depicted. System 700 includes trunk body 121, trunk body 161, electrical connector 22 and electrical connector 230.

Trunk body 121 includes narrow end 604 with flanged portion 608; trunk portion 161 comprises a generally circular, hollow trunk defining end 605 and interior cavity 607.

Electrical connector 222 comprises first end 702, second end 704, annular surface 706, top surface 708, electric terminals 223 and 225. Electrical connector 222 defines keyway or channel 710 extending downwardly from surface 708 towards annular surface 706. In an alternate embodiment, electrical connector 222 may also define a second keyway 710 located opposite first keyway 710.

First end 702, in an embodiment has a diameter general less than a diameter of second end 704, thusly forming annular surface 706. Electric terminals 223 and 225 in an embodiment comprise female-style electric terminals or contacts, and are embedded in second end 704 as depicted.

Electrical connector 230 includes body 720, rib or key 722, inside surface 724, top surface 726, electrical terminals 231 and 233. Body 720 defines cavity 728 configured to receive first end 702. Rib 722 extends alone inside surface 724 in a downwardly direction. Electrical terminals 231 and 233 in an embodiment comprise male electrical terminals which project upwardly within cavity 728. In an alternate embodiment, electrical connector 230 includes a second key 722 opposite first key 722.

Electrical connector 222 during manufacturing assembly is inserted into narrow end 604 of trunk body 121 and secured. In an embodiment, top surface 708 is coplanar with the very end of end 604.

Electrical connector 230 during manufacturing assembly is inserted into an end of trunk body 161. In an embodiment, electrical connector 230 is inserted a distance into trunk body 161 such that it is not adjacent an opening of the end of trunk body 161. In an alternate embodiment, electrical connector 222 is inserted into trunk body 161, and electrical connector 230 is inserted into trunk body 121.

When a user couples trunk body 121 with electrical connector 222 to trunk body 161 having electrical connector 230, trunk body 161 confronts trunk body 121 and the bodies are aligned along a vertical Axis A. Initially, no particular rotational alignment or orientation is required to fit narrow end 604 of trunk body 121 into cavity 607 of trunk body 161.

As end 604 is inserted into cavity 607, electrical contact 222 will make contact with electrical contact 230. If key 722 is aligned rotationally with keyway 710, then second end 704 of electrical connector 222 will fit into cavity 728 of electrical connector 230, and electrical connectors 222 and 230 can be fully coupled such that annular surface 706 contacts top surface 726.

If key 722 is not initially aligned with keyway 710, a user may rotate either of trunk body 121 or 161, and hence electrical connectors 222 and 230 so as to align the key and keyway. In an embodiment, a user initially inserts end 604 into cavity 607, allows key 722 to contact top surface 708 in misalignment, then rotates trunk section 161 until key 722 aligns with keyway 710 and trunk body 161 and electrical connector 230 fall downwards onto trunk body 121. The ability to couple trunk body 121 to trunk body 161 in part, followed by aligning the electrical connectors makes it easier to assemble tree 100.

In such a configuration, the electrical connectors 222 and 230 form a one-way keyed pair, while trunk bodies 121 and 161 are not keyed, and can be coupled in any orientation. the weight of tree portion 106 and trunk body 161. Alternatively, when electrical connectors 222 and 230 include pairs of keyways 710 and keys 722, respectively, system 700 forms a two-way keyed electrical connection and tree trunk connection system.

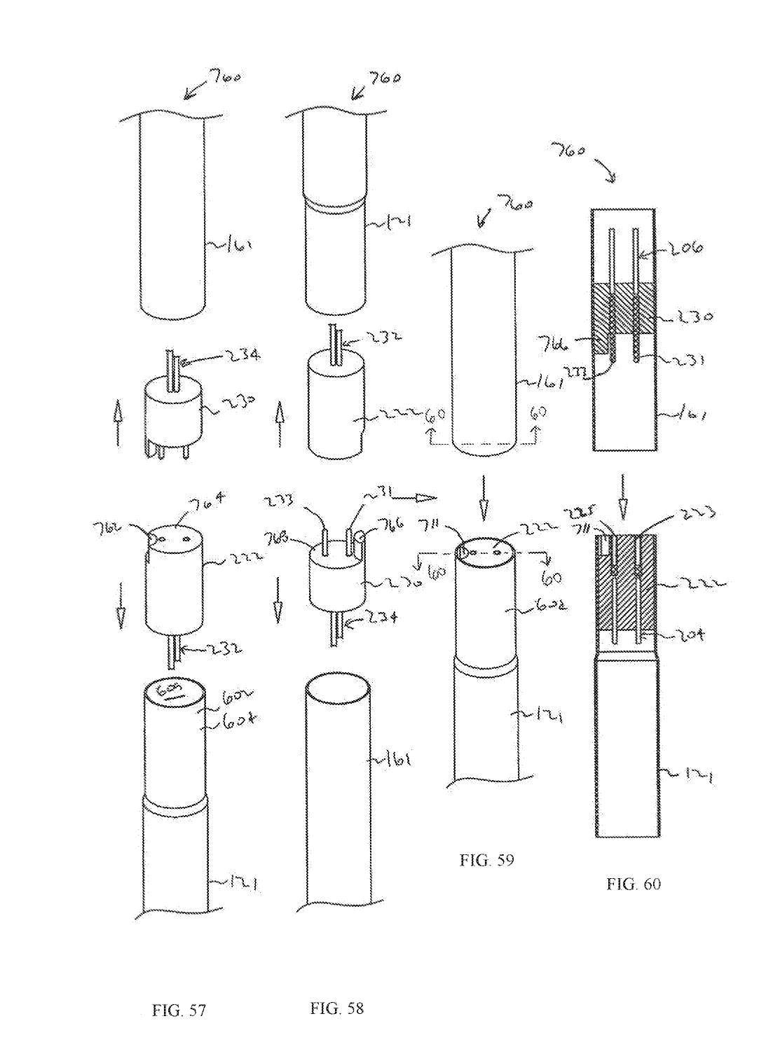

Referring to FIGS. 57-60, tree trunk keying system 760 is depicted. System 760 is substantially the same as system 700, but with a somewhat different key and keyway pair and electrical connector set.

System 760 includes trunk body 161, trunk body 121, electrical connector 222 and electrical connector 230. Trunk bodies 121 and 161 are the same as those described earlier, and can be coupled in any rotational orientation or alignment, such that they are not keyed. Electrical connector 22s is similar to previously-described electrical connectors 222, and includes keyway 762 extending downwardly from top surface 764 of electrical connector 222. In an embodiment, electrical connector 222 includes a second keyway 762 opposite first keyway 762.

Electrical connector 230 includes key 766 extending upward and away from top surface 768 of electrical connector 230. In an embodiment, a length of key 766 is substantially the same as, or somewhat longer than, a length of one of electrical terminals 231 or 233. In the depicted embodiment, key 766 is located generally at a periphery of top surface 768.

Electrical connector 230 is inserted into trunk body 161; electrical connector 222 is inserted into trunk body 121. When electrical connector 222 is inserted into trunk body 121, a portion of trunk body wall 602, and an inside surface 609 cooperate with keyway 762 to form a multi-sided keyway for key 766. Such a multi-sided keyway is depicted in FIG. 59 as reference numeral 711.

Similar to system 700, system 760 provides a one-way or two-way keyed electrical connection and tree trunk connection system that prevents rotation of tree trunk sections and tree portions relative to one another, thusly protecting the aesthetics of a decorated or lighted tree, while preserving the integrity of any light strings on the tree.

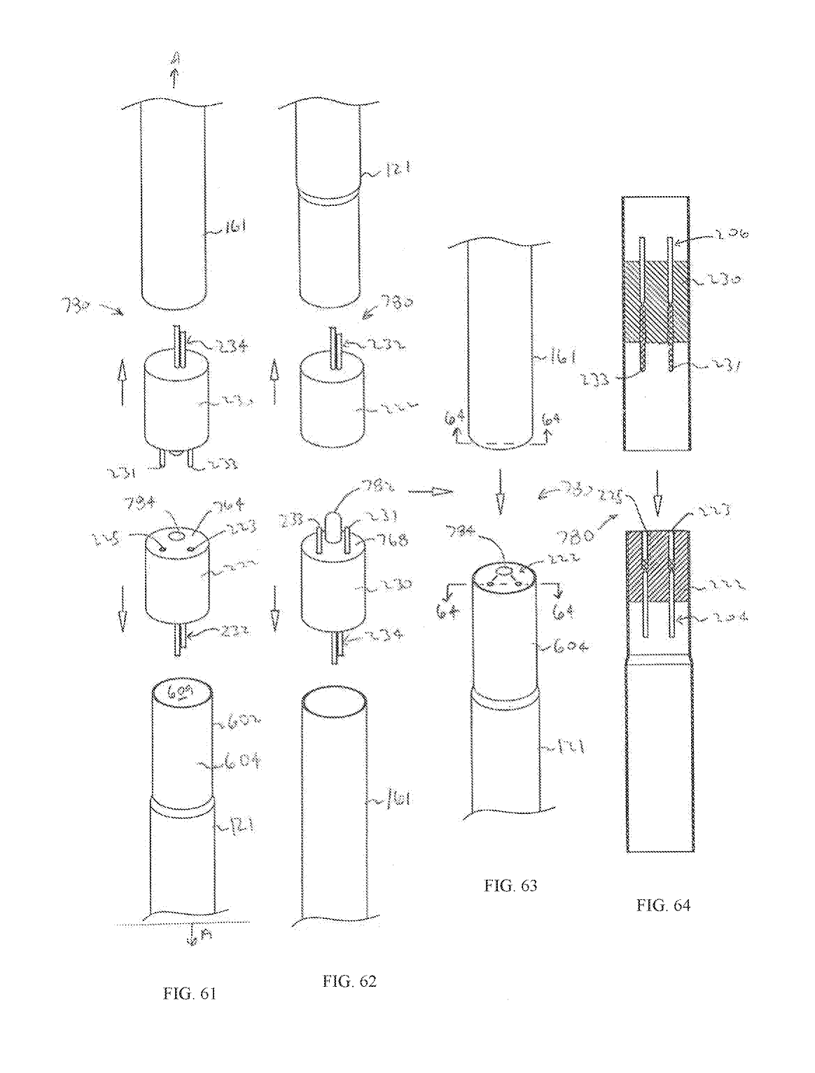

Referring to FIGS. 61-64 another embodiment of a tree trunk keying system, system 780, is depicted. System 780 is substantially similar to system 760 as depicted in FIGS. 57-60, with the exception of the key and keyway.

System 780 includes key 782 in electrical connector 230 and keyway 784 in electrical connector 222. In an embodiment, and as depicted, key 782 forms a projection portion projecting upwardly and away from surface 768 of electrical connector 230. A height of key 782 is approximately the same as a height of electrical terminal 231 or 233, though in other embodiments, a height of key 782 may be longer so as to provide some degree of protection to electrical terminals 231 and 233, or in other embodiments, may be shorter than terminals 231 or 233. In an embodiment, key 782 is generally cylindrical with a convex, rounded tip. Such a rounded tip makes it easier for a user to locate key 782 into keyway 784.

In an embodiment, key 782 is positioned in a non-central location with respect to surface 764. In one such embodiment, key 782 is located centrally along a left-to-right axis, but non-central along a front-to-back axis, as depicted in FIG. 161. In an alternate embodiment, key 782 is located in the center of surface 768 of electrical connector 230.

In an embodiment, electrical terminals 231 and 233 extend upwardly and away from surface 768, and are positioned generally opposite one another. In an embodiment, terminal 231, terminal 233, and key 785 are spaced apart to form a triangular area between themselves, as depicted in FIG. 62. In embodiment, terminal 231, terminal 233 and key 782 are equidistant one another, and may have equal heights, which may aid a user in coupling connectors 222 and 230.

Further, the use of a keyway that is thicker and less susceptible to bending, as compared to terminals 231 and 233 minimizes the likelihood of terminals 231 or 233 being bent when electrical connectors 222 and 230 are coupled.

Keyway 784 is generally complementary and positioned and sized to receive key 782. As depicted, keyway 784 is generally circular so as to receive key 782. As depicted, and in an embodiment, keyway 784 is non-centrally located with respect to surface 764, and may be equidistantly spaced apart from electrical terminals 223 and 225.

The various embodiments of tree trunk keying systems as described and depicted above provide a number of features to enhance the assembly, safety, and operation of modern, multi-sectional artificial trees, including modular lighted trees of the claimed invention.

The embodiments above are intended to be illustrative and not limiting. Additional embodiments are within the claims. In addition, although aspects of the present invention have been described with reference to particular embodiments, those skilled in the art will recognize that changes can be made in form and detail without departing from the spirit and scope of the invention, as defined by the claims.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. An artificial tree defining a central vertical axis, the tree comprising:
a first trunk body, a first electrical connector located within the first end of the first trunk body, the first electrical connector including a first electrical terminal and a second electrical terminal; and
a second trunk body, a second electrical connector located within the first end of the second trunk body, the second electrical connector including a first electrical terminal and a second electrical terminal.
